(19) United States
(12) Patent Application Publication
(10) Pub. No.: US 2011/0304936 A1
(43) Pub. Date: Dec. 15, 2011

(54) DATA DEMODULATING DEVICE, DATA DEMODULATING METHOD, AND PROGRAM

(75) Inventor: Toshiyuki NAKAGAWA, Kanagawa (JP)

(73) Assignee: Sony Corporation, Tokyo (JP)

(21) Appl. No.: 13/108,208

(22) Filed: May 16, 2011

(30) Foreign Application Priority Data
Jun. 11, 2010 (JP) 2010-134035
Jun. 15, 2010 (JP) 2010-135914

(51) Int. Cl. G11B 5/09

(52) U.S. Cl. 360/48; G9B/5.033

(57) ABSTRACT

A data demodulating device which converts an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to the modulation table, includes: a shaping unit configured to subject to two or more signal processes; and a selecting unit configured to select the content of the signal process by the shaping unit based on the information bits.

### BACKGROUND

The present disclosure relates to a data modulating device, a data modulating method, a data demodulating device, a data demodulating method, and a program, and specifically relates to a data modulating device, a data modulating method, a data demodulating device, a data demodulating method, and a program, whereby playback properties can further be stabilized.

At the time of transmitting data via a predetermined transmission path, or recording data in a recording medium such as a magnetic disk, an optical disc, a magneto-optical disk, or the like, modulation of the data is performed according to transmission paths or recording media.

Block coding is one of such modulating methods in use. Block coding is for blocking a data string into units made up of m×i bits (hereafter, referred to as data word), and converting a data word into a code word made up of n×i bits in accordance with a suitable coding rule. Hereafter, the bits of a code word will also be referred to as channel bits.

A code becomes a fixed-length code at the time of i=1, and also becomes a variable-length code at the time of two or more i being able to be chosen, i.e., at the time of a predetermined i of 1 through imax (the maximum i) being chosen. A code subjected to block coding is represented as a variable-length code (d, k;m, n;r).

Hereinafter, i will be referred to as restricted length, and imax becomes the maximum restricted length. Also, d indicates the number of the minimum continuous “0”s to be inserted between continuous “1”s, i.e., indicates the minimum run of “0”s, and k indicates the number of the maximum continuous “0”s to be inserted between continuous “1”s, i.e., indicates the maximum run of “0”s.

In the event of recoding a code word thus obtained in an optical disc such as a CD or the like, or a magneto-optical disk such as a MD or the like, NRZI (NonReturn to Zero Inverted) modulation is performed wherein “1” of a variable-length code string is inverted, and “0” thereof is not inverted, and a variable-length code after NRZI modulation is recorded. Such a recording method is referred to as mark edge recording. Hereafter, a variable length code serving as a recorded object will be referred to as a recorded code string.

On the other hand, with a 3.5-inch magneto-optical disk having capacity of 230 MB conforming to the ISO standard, or the like, a modulated code string is recorded without NRZI modulation. Such a recording method is called mark position recording. With such current recording media having high-recording density, mark edge recording is frequently used.

If we take the minimum inversion interval of recorded code strings as Tmin, and take the maximum inversion interval as Tmax, in order to perform high-density recording in the linear velocity direction, the longer the minimum inversion interval Tmin is, i.e., the greater the minimum run d is, the better. Also, as far as clock recovery is concerned, the shorter the maximum inversion interval Tmax is, i.e., the smaller the minimum run k is, the better.

Also, taking overwriting property into consideration, the smaller Tmax/Tmin is, the better. Further, various modulating methods have been proposed and come into practical use in light of conditions of media, such as it being important to increase detection window width Tw=m/n from the perspective of dealing with jittering and S/N ratio.

Now, description will be made regarding a modulating method that has proposed or come into practical use with optical discs, magnetic disks, magneto-optical disks, and so forth.

EFM codes used for CDs or MDs (also represented with (2, 10;8, 17;1)), 8-16 codes used for DVDs (also represented with (2, 10;1, 2;1)), and RLL (2, 7) used for PD (120-mm 650-MB capacity) (also represented with (2, 7;m, n;r)) are RLL codes of the minimum run d=2.

Also, MD-DATA2, or RLL (1, 7) used for 3.5-inch MOs conforming to the ISO standard (640-MB capacity) (also represented with (1, 7;2, 3;r) are RLL codes of the minimum run d=1.

Additionally, with optical discs, magneto-optical disks, and so forth having high recording density, which are currently being researched and developed, RLL codes (Run Length Limited code) of the minimum run d=1 that are balanced in the size of the minimum mark, and conversion efficiency are frequently used. Further, in the event that it is desirable to use a recording method whereby a mark interval can widely be taken according to recording playback properties, mark position recording is employed, and RLL codes such as the minimum run d=1, d=2, d=4, or the like are used according to recording density.

FIG. 1 is a diagram illustrating an example of a modulation/demodulation table of variable-length RLL (1, 7) codes.

With the modulation/demodulation table in FIG. 1, for example, in the event of the restricted length i=1, the data pattern of “11” is modulated into the code pattern of “00x”. Also, in the event of the restricted length i=2, the data pattern of “0011” is modulated into the code pattern of “000 00x”.

x in the modulation/demodulation table in FIG. 1 is set to “1” when the following channel bit is “0”, and is set to “0” when the following channel bit is “1”. The maximum restricted length r is 2.

The parameter of a variable-length RLL (1, 7) is (1, 7;2, 3, 2), and if we say that the bit interval of a recorded code string is taken as T, the minimum inversion interval Tmin represented with (d+1)T becomes 2 (=1+1)T. If we say that the bit interval of a data string is taken as Tdata, the minimum inversion interval Tmin represented with (m/n)×2 becomes 1.33 (=(2/3)×2)Tdata.

Also, the maximum inversion interval Tmax represented with (k+1)T is taken as Tmax=8 (=7+1)T (=(m/n) 8 Tdata=(2/3)×8 Tdata=5.33 Tdata). Further, the detection window width Tw is represented with (m/n)×Tdata, and the value thereof becomes Tw=0.67 (=2/3) Tdata.

Incidentally, with a channel bit string obtained by performing modulation in accordance with the modulation/demodulation table in FIG. 1, 2T that is Tmin has the most occurrence frequency, and hereafter, the occurrence frequency is high in 3T, 4T, 5T, 6T, and so on in this order. It may be advantageous for clock recovery that 2T that is the minimum run (Tmin) is repeated, i.e., that edge information frequently occurs with an early cycle.

However, for example, with recording/playback of an optical disc, in the event of further increasing the recording linear density, the portion of the minimum run becomes a portion where an error readily occurs. This is because the waveform output of the minimum run is smaller than other runs at the time of playback of the optical disc, and readily is influenced by defocus, tangential tilt, and so forth.

Also, recording/playback of continuity of the minimum marks with high linear density is readily influenced by disturbance such as noise and so forth, and data playback error readily occurs. There is a pattern where an error is caused by from the head edge to the last edge of continuous minimum marks being shifted at once. Specifically, a bit error is propagated from the head to the last of sections where the minimum runs are continued. Accordingly, the length of error propagation lengthens.

Accordingly, in order to realize stabilization in the event of recording/playing data with high linear density, it is effective to restrict continuity of the minimum runs.

On the other hand, at the time of recording of data in a recording medium, or transmission of data via a transmission path, as described above, modulation suitable for a recording medium or transmission path is performed, but in the event that a low-frequency component is included in modulation codes, variation of various types of error signal such as a tracking error and so forth readily occurs at the time of servo control at a disk playback device, or jitter readily occurs. Accordingly, with modulation codes, it is desirable that low-frequency components are suppressed as much as possible.

There is DSV (Digital Sum Value) control as a method for suppressing low-frequency components. DSV means summation at the time of subjecting a channel bit stream to NRZI (level coding) to obtain a recorded code string, and adding the value of each bit with “1” of a bit of the recorded code string as “+1”, and “0” as “−1”. DSV serves as a rough indication of a low-frequency component in a recorded code string. Decreasing the absolute value of negative/positive deviation of DSV, i.e., performing DSV control serves to remove the DC components of the recorded code string and to suppress low-frequency components.

Modulated codes obtained by using the modulation/demodulation table in FIG. 1 have not been subjected to DSV control. DSV control in such a case is realized by performing DSV computation of the channel bit string after modulation with a predetermined interval, and inserting a DSV bit into the channel bit string (e.g., see Japanese Unexamined Patent Application Publication No. 11-177431).

The number of DSV bits to be inserted into the channel bit string is determined by the minimum ruin d. For example, in the event of d=1, the number of DSV bits used for inserting into the channel bit string so as to keep the restriction of the minimum run is 2 (=d+1). Also, the number of DSV bits used for inserting into the channel bit string so as to keep the restriction of the maximum run is 4 (=2×(d+1)). In the event of performing DSV control with DSV bits of which the number is smaller than the number of those bits, there may be a case where DSV control is not allowed to be performed depending on the previous and next pattern that will sandwich DSV bits.

With the RLL (1, 7) code that is (d, k;m, n)=(1, 7;2, 3), upon converting the DSV bits into data in accordance with a conversion rate, the number of data thereof becomes as follows.

4 channel bits×2/3=8/3=equivalent to 2.67 data (2.67 Tdata)

Incidentally, DSV bits are basically redundant bits. Accordingly, the smaller the number of DSV bits can be made to be, the better, from a point of view of code conversion efficiency.

Also, it would be better that the minimum run d and the maximum run k are not changed according to DSV bits to be inserted, since changing (d, k) influences the recording/playback properties.

With actual RLL codes, the minimum run has great influence as to the recording/playback properties, and accordingly it is important that this is kept, but the maximum run is not kept without exception. There may a format where a pattern for breaking the maximum run is used as the pattern of a synchronous signal. For example, the maximum run of 8-16 codes of DVD is 11T, but with the synchronous signal portion, improvement in detection capabilities of the synchronous signal is realized by giving 14T exceeding the maximum run.

### SUMMARY

However, even in the event that it has been stipulated by a format to perform DSV control, there may be a case where DSV control is unnecessary depending on the system.

In the event that suppression of DC components does not have to be performed as to a predetermined format with regard to the system, bits for DSV control sandwiched with a predetermined interval become redundant bits.

Also, even in the event that suppression of DC components has to be performed, even when suppression of DC components is successively performed as to the predetermined format as the system, it can be conceived that DSV bits sandwiched with a predetermined interval are redundant bits.

It has been found to be desirable to enable playback properties to be further stabilized.

A data modulating device according to an embodiment of the present disclosure includes: an inserting unit configured to insert a special bit having a value representing the content of a signal process at the time of demodulating data within a target section into a data string input as a modulation object; a conversion unit configured to convert the data string into which the special bit is inserted into an RLL code string in accordance with a modulation table having a variable-length conversion rule; a setting unit configured to set the RLL code string to a control section; and a control unit configured to determine a value representing the content of a signal process at the time of demodulating the RLL codes within the control section into data as the value of the special bit.

The control unit may determine, based on the RLL codes within the control section, a value representing the content of a signal process at the time of demodulating the RLL codes within the control section as the value of the special bit.

An arrangement may be made wherein the setting unit sets the RLL code string to each of a first control section and a second control section as the control sections, the control unit determines, based on the RLL codes within the first control section, the value of a DSV bit used for DSV control of the RLL codes within the first control section, and determines the value of the special bit representing the content of a signal process at the time of demodulating the RLL codes within the second control section into data, and the inserting unit inserts the special bit into at least a partial position of positions set to the data string with a constant interval as the insertion position of the DSV bit, and inserts the DSV bit into other positions.

The control unit may determine the value of the special bit representing the content of a signal process at the time of demodulating the RLL codes within the second control section based on the RLL codes within the second control section.

In the event that the RLL codes are recorded in a recording medium, the control unit may change the value of the special bit according to a recorded position of the recording medium of the RLL codes within the second control section.

In the event that the RLL codes are recorded in a recording medium, the control unit may change the value of the special bit according to a recorded position of the recording medium of the RLL codes within the control section.

The control unit may analyze continuity of zeros or continuity of ones of the RLL codes of the second control section, and change the value of the special bit according to whether or not the number of times of occurrence of the minimum run is greater than a threshold.

The control unit may analyze continuity of zeros or continuity of ones of the RLL codes of the control section, and change the value of the special bit according to whether or not the number of times of occurrence of the minimum run is greater than a threshold.

There may be provided a synchronous signal generating unit configured to generate a synchronous signal including identification information representing whether or not the special bit is included in the data string. In this case, the conversion unit may synthesize the RLL code string with the synchronous signal.

A data modulating method according to an embodiment of the present disclosure includes: inserting a special bit having a value representing the content of a signal process at the time of demodulating data within a target section into a data string input as a modulation object; converting the data string into which the special bit is inserted into an RLL code string in accordance with a modulation table having a variable-length conversion rule; setting the RLL code string to a control section; and determining a value representing the content of a signal process at the time of demodulating the RLL codes within the control section into data as the value of the special bit.

A program according to an embodiment of the present disclosure causes a computer to execute processing including: inserting a special bit having a value representing the content of a signal process at the time of demodulating data within a target section into a data string input as a modulation object; converting the data string into which the special bit is inserted into an RLL code string in accordance with a modulation table having a variable-length conversion rule; setting the RLL code string to a control section; and determining a value representing the content of a signal process at the time of demodulating the RLL codes within the control section into data as the value of the special bit.

A recording medium according to an embodiment of the present disclosure is a recording medium recording a recorded coded string generated by inserting a special bit having a value representing the content of a signal process at the time of demodulating data within a target section into a data string input as a modulation object, converting the data string into which the special bit is inserted into an RLL code string in accordance with a modulation table having a variable-length conversion rule, setting the RLL code string to a control section, and determining a value representing the content of a signal process at the time of demodulating the RLL codes within the control section into data as the value of the special bit.

With an embodiment of the present disclosure, a special bit having a value representing the content of a signal process at the time of demodulating data within a target section is inserted into a data string input as a modulation object, the data string into which the special bit is inserted is converted into an RLL code string in accordance with a modulation table having a variable-length conversion rule. Also, a control section is set to the RLL code string, and a value representing the content of a signal process at the time of demodulating the RLL codes within the control section into data is determined as the value of the special bit.

A data demodulating device according to an embodiment of the present disclosure is a data demodulating device which converts an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to the modulation table, including: a shaping unit configured to subject to two or more signal processes; and a selecting unit configured to select the content of the signal process by the shaping unit based on the information bits.

There may further be provided a first conversion unit configured to convert the RLL codes into a first data string in accordance with the demodulation table corresponding to the modulation table, a setting unit configured to set the first data string to a control section which is an object of the information bits, and a second conversion unit configured to convert the RLL code string made up of the RLL codes subjected to the signal process by the shaping unit into a second data string in accordance with the demodulation table. In this case, an arrangement may be made wherein the shaping unit subjects the RLL code of a section corresponding to the control section which is an object of the special bit, of RLL codes included in the RLL code string, to a different signal process according to the value of the special bit, and the selecting unit outputs the second data string as playback data of the control section which is an object of the special bit, and outputs the first data string as other playback data of the control section.

The information bits may include DSV bits used for DSV control of a target section, and the special bit inserted instead of a part of the DSV bits.

In the event that the input signal is a signal obtained by playing a recording medium, the value of the special bit may differ according to recoded positions in the recording medium of the RLL codes obtained by modulating data within a target section in accordance with the modulation table.

The value of the special bit may differ according to whether or not the number of times of occurrence of the minimum run that is succession of zeros or succession of ones of the RLL codes obtained by modulating data within a target section in accordance with the modulation table is greater than a threshold.

There may further be provided a detecting unit configured to detect a synchronous signal including identification information representing whether or not the special bit is inserted into the data string that has been synthesized with the RLL code string. In this case, the selecting unit may perform, in the event that the identification information included in the synchronous signal represents that the special bit is inserted into the data string, output of the second data string.

There may further be provided a determining unit configured to determine whether or not the special bit is inserted into the data string, based on change of the values of the information bits. In this case, the selecting unit may perform, in the event that determination is made that the special bit is inserted into the data string so that the values of the information bits have not been changed for a certain period or more, output of the second data string.

There may further be provided a computing unit configured to perform a DSV computation of the control section set by the setting unit which is an object of the DSV bits, based on DSV bits used for DSV control of a target section included in the information bits, and the DSV bits of the special bits inserted instead of a part of the DSV bits, and a determining unit configured to determine whether or not the special bit is inserted into the data string by comparing the results of the DSV computation and a threshold. In this case, the selecting unit may perform, in the event that determination is made that the special bit is inserted into the data string since the results of the DSV computation is greater than the threshold, output of the second data string.

A data demodulating method according to an embodiment of the present disclosure is a data demodulating method of a data demodulating device including a shaping unit which subject to two or more signal processes which convert an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to the modulation table, including: selecting the content of the signal process by the shaping unit based on the information bits.

A program according to an embodiment of the present disclosure is a program causing a computer to execute processing of a data demodulating device including a shaping unit which subject to two or more signal processes which convert an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to the modulation table, including: selecting the content of the signal process by the shaping unit based on the information bits.

According to the above configurations, the content of a signal process by the shaping unit is selected based on information bits including a special bit having a value representing the content of a signal process at the time of demodulating data within a target section included in an input signal. According to the above configurations, playback properties can further be stabilized.

### BRIEF DESCRIPTION OF THE DRAWINGS

FIG. 1 is a diagram illustrating an example of a modulation/demodulation table;

FIG. 2 is a diagram illustrating another example of the modulation/demodulation table;

FIG. 3 is a block diagram illustrating a basic configuration of a data demodulating device;

FIG. 4 is a diagram illustrating an example of a playback data string;

FIG. 5 is a flowchart for describing playback processing of the data demodulating device in FIG. 3;

FIG. 6 is a flowchart for describing control section determination processing to be performed in step S6 in FIG. 5;

FIGS. 7A and 7B are diagrams illustrating an example of a control section;

FIG. 8 is a diagram illustrating an example of a control section made up of a DSV control section;

FIG. 9 is a diagram illustrating an example of a control section made up of a special computation section;

FIG. 10 is a diagram illustrating another example of a control section made up of the special computation section;

FIG. 11 is a diagram illustrating an example of a control section made up of the DSV control section and the special computation section;

FIG. 12 is a diagram illustrating another example of a control section made up of the DSV control section and the special computation section;

FIG. 13 is a diagram illustrating yet another example of a control section made up of the DSV control section and the special computation section;

FIG. 14 is a block diagram illustrating a specific example of the configuration of the data demodulating device;

FIG. 15 is a block diagram illustrating a modification of the configuration of the data demodulating device in FIG. 14;

FIG. 16 is a flowchart for describing playback processing of the data demodulating device in FIG. 14;

FIG. 17 is a block diagram illustrating another specific example of the configuration of the data demodulating device;

FIG. 18 is a block diagram illustrating a modification of the configuration of the data demodulating device in FIG. 17;

FIG. 19 is a flowchart for describing playback processing of the data demodulating device in FIG. 17;

FIG. 20 is a block diagram illustrating another specific example of the configuration of the data demodulating device;

FIG. 21 is a block diagram illustrating a modification of the configuration of the data demodulating device in FIG. 20;

FIG. 22 is a flowchart for describing playback processing of the data demodulating device in FIG. 20;

FIG. 23 is a block diagram illustrating the configuration of a personal computer;

FIG. 24 is a block diagram illustrating the basic configuration of a data modulating device;

FIG. 25 is a block diagram illustrating a configuration example of the data modulating device;

FIG. 26 is a flowchart for describing record code string generation processing of the data modulating device;

FIG. 27 is a flowchart for describing control section determination processing to be performed in step S5 in FIG. 26;

FIG. 28 is a block diagram illustrating another configuration example of the data modulating device;

FIG. 29 is a block diagram illustrating another configuration example of the data modulating device; and

FIG. 30 is a block diagram illustrating another configuration example of the data modulating device.

### DETAILED DESCRIPTION OF EMBODIMENTS

### First Embodiment

### Modification/Demodulation Table

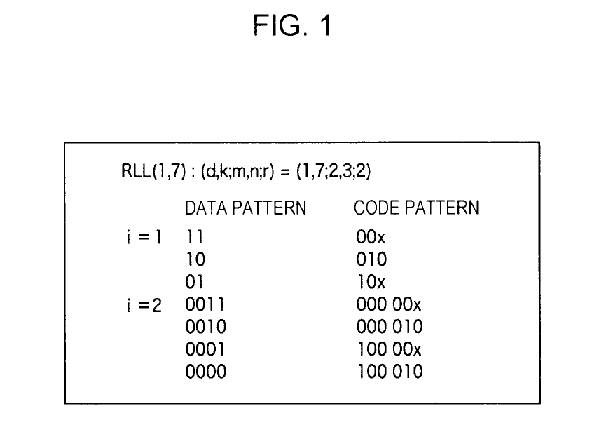

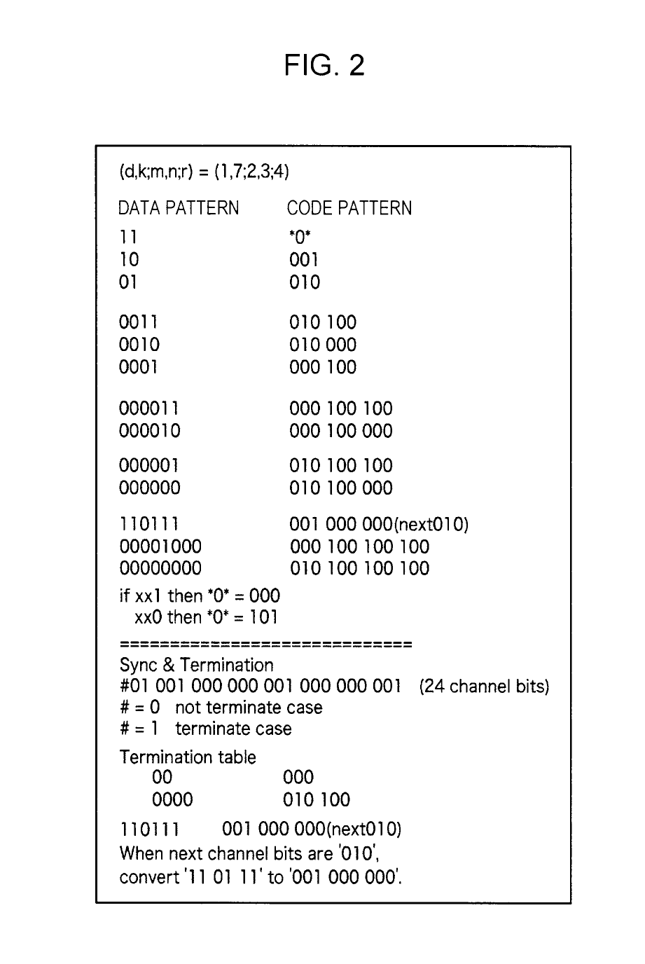

The modulation/demodulation table shown in FIG. 2 is a modulation/demodulation table of RLL codes of the minimum run d=1 corresponding to high recording density as compared to the modulation/demodulation table in FIG. 1. Here, a data modulating device converts a data pattern into a code pattern with the table in FIG. 2 as a modulation table. On the other hand, a data demodulating device converts a code pattern into a data pattern using substantially the same table as the modulation table with the table in FIG. 2 as a demodulation table. FIG. 2 serves as the modulation table, and also serves as the demodulation table.

The modulation/demodulation table in FIG. 2 includes basic patterns, replacement patterns, and termination patterns as conversion patterns. The basic patterns are conversion patterns used for conversion processing, i.e., conversion processing is unavailable without these. The conversion patterns of data patterns from (11) to (000000) are basic patterns.

The replacement patterns are conversion patterns not used for conversion processing, i.e., conversion processing is available without these, but more effective conversion processing can be performed using these. The conversion pattern of data patterns (110111), (00001000), and (00000000) are replacement patterns.

The termination patterns are conversion patterns for terminating a data string at an arbitrary position. The conversion patterns of data patterns of (00) and (0000) are termination patterns.

Also, the modulation/demodulation table in FIG. 2 is a modulation/demodulation table of the minimum run d=1, and the maximum run k=7, an uncertain code (code represented with *) is included in the elements of a basic pattern. The uncertain code is determined to be “0” or “1” regardless of the immediately previous and immediately subsequent code word strings.

Specifically, with the modulation/demodulation table in FIG. 2, when the data pattern is (11), according to the immediately previous code word string (channel bit string) thereof, a code pattern of “000” or “101” is selected, and the data pattern is converted into one thereof. For example, in the event that one channel bit of the immediately previous code word string is “1”, the data pattern (11) is converted into “000” so as to keep the minimum run d. Also, in the event that one channel bit of the immediately previous code word string is “0”, the data pattern (11) is converted into “101” so as to keep the maximum run k.

The basic patterns in the modulation/demodulation table in FIG. 2 have a variable-length structure. Specifically, a basic pattern with the restricted length i=1 is structured of three (*0*, 001, 010) less than four serving as an appropriate number (2̂m=2̂2=4). As a result thereof, at the time of converting a data string, there may be a data string that is not converted with the restricted length i=1 alone. Eventually, in order to convert all of the data strings using the modulation/demodulation table in FIG. 2 (in order to be used as a modulation/demodulation table), basic patterns up to the restricted length i=3 have to be referenced.

The modulation/demodulation table in FIG. 2 includes replacement patterns for restricting continuity of the minimum run d. Accordingly, in the event that the data pattern is (110111), the following code word string thereof is referenced, and when this is “010”, the data pattern of (110111) is replaced with a code pattern “001 000 000”.

Also, in the event that the following code word string is other than “010”, the data pattern is converted into a code pattern with two data units of (11), (01), and (11), and accordingly, converted into “*0*010*0*”. Thus, continuity of the minimum run is restricted, the code word string becomes repetition of the minimum run up to six times at a maximum.

The maximum restricted length r of the modulation/demodulation table in FIG. 2 is 4. The conversion pattern of restricted length i=4 is structured of a replacement pattern (maximum run assured pattern) for realizing the maximum run k=7. Specifically, an arrangement is made wherein a data pattern (00001000) is converted into a code pattern “000 100 100 100”, and a data pattern (00000000) is converted into a code pattern “010 100 100 100”. In this case as well, the minimum run d=1 is kept.

Further, with the modulation/demodulation table in FIG. 2, in the event that termination is performed at an arbitrary position of the data string so as to sandwich a synchronous pattern, a termination pattern is employed at the time of the data string being positioned in a termination position at (00) or (0000).

With the synchronous pattern to be inserted, the head one code word is a termination pattern use identification bit, and when a termination pattern is employed, the head code word of the immediately subsequent synchronous pattern string is “1”. Also, when no termination code is employed, the head code word of the immediately subsequent synchronous pattern string is “0”.

Note that a synchronous pattern in the modulation/demodulation table in FIG. 2 is structured of 24 code words in total of a termination pattern use identification bit, and bits obtained by repeating a code pattern of k=8 exceeding the maximum run k=7 for detection the synchronous pattern two times.

The modulation/demodulation table in FIG. 2 has a conversion rule such that a remainder at the time of dividing the number of “1”s serving as elements of a data pattern by 2, and a remainder at the time of dividing the number of “1”s serving as elements of a code pattern to be converted by 2, are both the same 1 or 0. That is to say, the conversion patterns in FIG. 2 have a conversion rule such that the number of “1”s of the corresponding any element is an odd number or even number.

That is to say, the modulation/demodulation table in FIG. 2 has a parity preservation pattern with relationship between data before conversion and a code after conversion. For example, a data pattern (000001) corresponds to a code pattern “010 100 100”, but the number of “1”s serving as each element is one with the data pattern, and three with the corresponding code pattern, and both match in that a remainder at the time of dividing by 2 is one (odd). Similarly, a data pattern (000000) corresponds to a code pattern “010 100 000”, but the number of “1”s serving as each element is zero with the data pattern, and two with the corresponding code pattern, and both match in that a remainder at the time of dividing by 2 is zero (even).

Next, DSV control will be described. As described above, with an RLL (1, 7) code obtained using the modulation/demodulation table in FIG. 1, DSV control has not been performed. DSV control in the past in such a case is performed, for example, after modulating a data string into a channel bit string, at least (d+1) DSV bits are added to the channel bit string with a predetermined interval.

DSV control can be performed as to a channel bit string obtained using the modulation/demodulation table in FIG. 2 in the same way as with the past, but DSV control can be performed further effectively by taking advantage of relationship between a data pattern and a code pattern of the modulation/demodulation table in FIG. 2.

Specifically, the modulation/demodulation table in FIG. 2 has a conversion rule such that a remainder at the time of dividing the number of “1”s serving as elements of a data pattern by 2, and a remainder at the time of dividing the number of “1”s serving as elements of a code pattern by 2, are both the same 1 or 0. At this time, inserting a DSV bit of “1” representing “inversion” or “0” representing “non-inversion” into the channel bit string is equivalent to inserting a DSV bit of “1” at the time of “inversion” or “0” at the time of “non-inversion” into the data bit string.

For example, with the modulation/demodulation table in FIG. 2, if we say that when three bits to be subjected to data conversion continue such as (001), a DSV bit is sandwiched thereafter, data becomes (001x) (x is one bit of “0” or “1”).

Here, in the event of providing “0” to x, according to the modulation/demodulation table in FIG. 2, the data pattern (0010) is converted into a code pattern “010 000”. In the event of providing “1” to x, the data pattern (0011) is converted into a code pattern “010 100”.

Upon performing NRZI upon the code word strings to generate a level code string, these become as follows.

| Data pattern | Code pattern | Level code string |
|---|---|---|
| 0010 | 010 000 | 011111 |
| 0011 | 010 100 | 011000 |

The last three bits of the level code strings are bits mutually inverted. This means that DSV control can be performed even within a data string by selecting “1” or “0” as the DSV bit x.

If we consider redundancy, performing DSV control using one bit within a data string is equivalent to performing DSV control using 1.5 channel bit according to a conversion rate (m:n=2:3) in FIG. 2, if this is represented with a channel bit string.

On the other hand, in order to perform DSV control with the modulation/demodulation table in FIG. 1, DSV control has to be performed with a channel bit string. At this time, in order to keep the minimum run, at least two channel bits have to be used, and redundancy increases as compared to DSV control with the modulation/demodulation table in FIG. 2. That is to say, when the modulation/demodulation table has a structure such as FIG. 2, DSV control can effectively be performed by performing DSV control within a data string.

The modulation/demodulation table such as FIG. 2 that can handle high recording density having the minimum run and the maximum run of (d, k)=(1, 7) has been employed with Blu-ray Disc (registered trademark) ReWritable ver.1.0 that is the format of a high-density optical disc, for example.

From now on, it can be conceived that even with a modulating method for data and channel bit of standard that can handle further high-recording density as to a high-density optical disc, a further stable system will be demanded.

At this time, if a further stable system is realized in addition to employ the modulation/demodulation table already employed as the system, the design technique in the past can be diverted, and accordingly, design risk at the time of hardware design can be decreased.

In the event that the modulation/demodulation table in FIG. 2 is employed for converting a code pattern into a data pattern, the modulation/demodulation table becomes a demodulation table. With a data demodulating device described below, the demodulation table in FIG. 2 will be employed.

### Configuration of Data Modulating Device

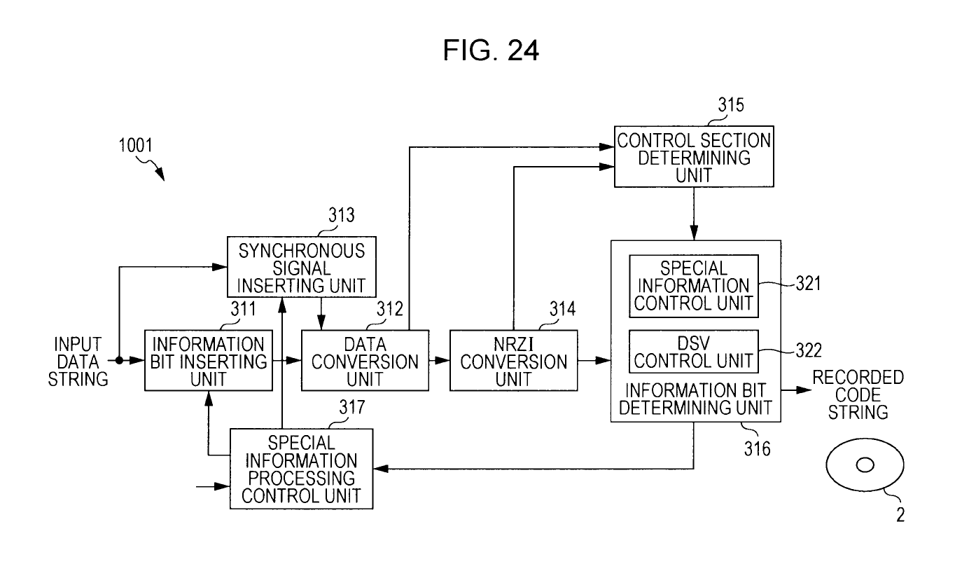

FIG. 24 is a block diagram illustrating the basic configuration of a data modulating device according to an embodiment of the present disclosure.

As illustrated in FIG. 24, a data modulating device 1001 is configured of an information bit inserting unit 311, a data conversion unit 312, a synchronous signal inserting unit 313, an NRZI conversion unit 314, a control section determining unit 315, an information bit determining unit 316, and a special information processing control unit 317. The information bit determining unit 316 is configured of a special information control unit 321 and a DSV control unit 322. A data string serving as a modulation object is input to the information bit inserting unit 311 and the synchronous signal inserting unit 313.

The information bit inserting unit 311 inserts an information bit into the input data string with a predetermined interval in accordance with the control by the special information processing control unit 317. The information bit that the information bit inserting unit 311 inserts is a special bit or DSV bit.

DSV bits are bits used for performing DSV control of a channel bit string at a device on the demodulation side for demodulating the recorded code string generated by the data modulating device 1001.

Special bits are bits used for switching the content of processing with a channel bit string as an object at the device on the demodulation side for demodulating the recorded code string generated by the data modulating device 1001. With the device on the demodulation side, the content of signal processing, for example, such as equalizer processing, PRML processing, or the like to be performed with a channel bit string as an object, is switched according to the value of a special bit.

For example, in the event that the recorded code string generated by the data modulating device 1001 is recorded in an optical disc such as Blu-ray Disc (registered trademark), there may a case where the property of a channel bit obtained by playback differs whether the recorded position is a position on the inner circumferential side or a position on the outer circumferential side. Accordingly, a special bit is inserted as information for controlling switching of signal processing such that signal processing corresponding to a recorded position in an optical disc of a channel bit obtained by playback is performed at the device on the demodulation side.

The information bit inserting unit 311 outputs a data string into which the information bit is inserted to the data conversion unit 312. Also, the information bit inserting unit 311 outputs position information representing the insertion position of the information bit as appropriate. The position information output from the information bit inserting unit 311 is used at each unit on the subsequent stage as appropriate.

The data conversion unit 312 converts the data supplied from the information bit inserting unit 311 into a channel bit string, for example, in accordance with the modulation table in FIG. 2. With the channel bit string, for example, the number of “0”s to be sandwiched between continuous “1”s is one at a minimum, and also seven at a maximum.

Also, the data conversion unit 312 synthesizes the channel bit string supplied from the information bit inserting unit 311, and the channel bit string of the synchronous signal pattern supplied from the synchronous signal inserting unit 313, and outputs to the NRZI conversion unit 314.

The synchronous signal inserting unit 313 generates, in sync with the input data string, a synchronous signal in accordance with the modulation table in FIG. 2, and outputs to the data conversion unit 312. The synchronous signal generated by the synchronous signal inserting unit 313 is a signal including 24 channel bits of “#01 001 000 000 001 000 000 001” shown in FIG. 2, for example. Note that the synchronous signal may be configured of greater number of channel bits than the 24 channel bits as appropriate. For example, multiple types of synchronous signals may be employed for the system or for identification of other objects.

The NRZI conversion unit 314 subjects the channel bit string supplied from the data conversion unit 312 to NRZI conversion (level coding). NRZI conversion is, as described above, conversion for performing inversion between 0 and 1 at the time of a channel bit of “1”, and keeping the current state at the time of a channel bit of “0”. The NRZI conversion unit 314 outputs the channel bit string subjected to NRZI conversion to the information bit determining unit 316. Hereafter, a code subjected to NRZI conversion will be referred to as a level code as appropriate.

The control section determining unit 315 sets a control section based on information relating to the level code supplied from the NRZI conversion unit 314, and information relating to variable length at the time of converting the data supplied from the data conversion unit 312 into channel bits. The control section determining unit 315 outputs information relating the position and type and so forth of each control section set to the channel bit string to the information bit determining unit 316. The types of control sections include a special computation section and a DSV control section.

The special information control unit 321 of the information bit determining unit 316 determines a special bit based on the channel bits of the special computation section set by the control section determining unit 315, and outputs the information of the determined special bit to the special information processing control unit 317.

The DSV control unit 322 of the information bit determining unit 316 performs DSV computation based on the channel bits of the DSV control section set by the control section determining unit 315. The DSV control unit 322 selects one of a bit string obtained by inserting 1 into the cannel bit string input from the NRZI conversion unit 314, and a bit string obtained by inserting 0 thereinto, as a DSV bit, and outputs as a recorded code string. The recorded code string output from the DSV control unit 322 is transmitted to another device via a predetermined transmission path, or recorded in a recording medium 2 such as Blu-ray Disc (registered trademark).

The special information processing unit 317 outputs the information of the special bit determined by the special information control unit 321 of the information bit determining unit 316 to the information bit inserting unit 311, and inserts the special bit into the input data string. Note that the special information processing control unit 317 outputs the information of the special bit determined by the special information control unit 321 of the information bit determining unit 316 to the synchronous signal inserting unit 313, whereby the information representing whether or not a special bit is included in the data string can be added to the synchronous signal.

Further, insertion of a special bit may be controlled based on a control signal input according to operations by the user of the data modulating device 1001 instead of control based on determination by the information bit determining unit 316. In this case, the special information processing control unit 317 controls the information bit inserting unit 311 in accordance with a control signal externally input to insert a special bit into the input data string. Also, the special information processing control unit 317 controls the synchronous signal inserting unit 313 in accordance with a control signal externally input to add information representing whether or not a special bit is inserted into the data string to the synchronous signal.

Note that the operation timing of each unit is controlled in sync with a timing signal supplied from an unshown timing control unit.

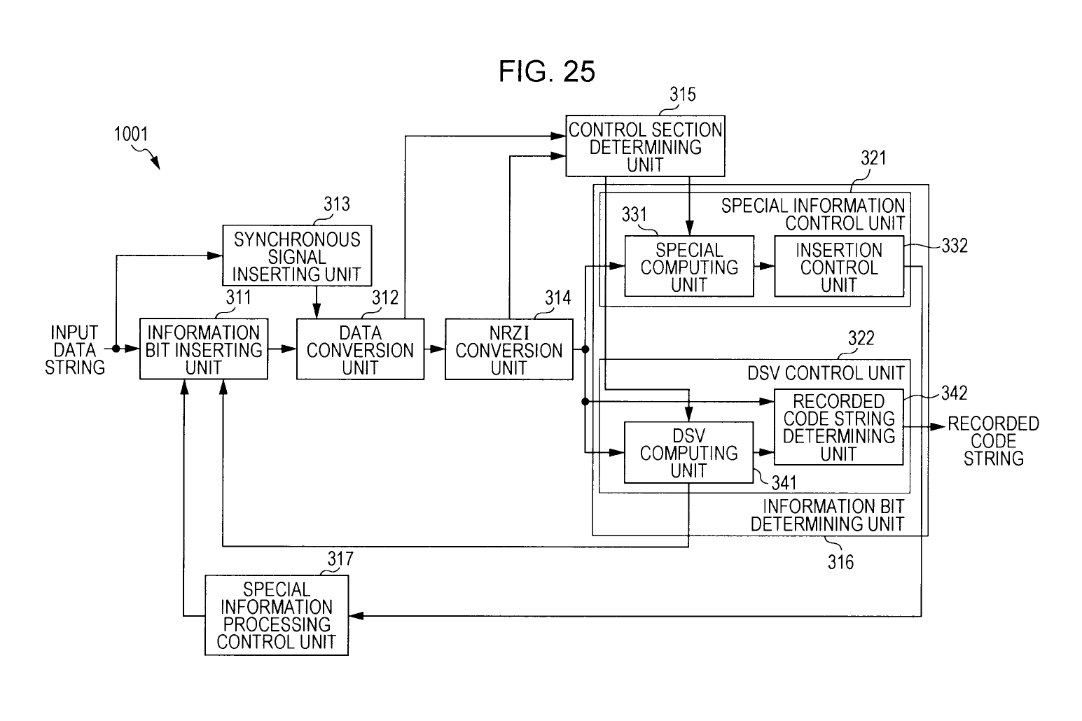

FIG. 25 is a block diagram illustrating a configuration example of the data modulating device 1001 in FIG. 24 in a more specific manner.

With the data modulating device 1001 in FIG. 25, the special information control unit 321 is configured of a special computing unit 331 and an insertion control unit 332. Also, the DSV control unit 322 is configured of a DSV computing unit 341 and a recorded code string determining unit 342.

The level signal output from the NRZI conversion unit 314 is supplied to the special computing unit 331 and the DSV computing unit 341, and also information relating to the control section supplied from the control section determining unit 315 is supplied thereto. The level code output from the NRZI conversion unit 314 is also supplied to the recorded code string determining unit 342 of the DSV control unit 322.

The special computing unit 331 performs computation relating a special bit based on of the level codes supplied from the NRZI conversion unit 314, and the level code of the special computation section set by the control section determining unit 315. For example, analysis of the run information of the level code of each special computation section, determination of a recoded position in the optical disc serving as the recording destination of a recorded code string are performed by the special computing unit 331. A recording position in the optical disc is determined based on the capacity of the optical disc, a position from the head of a special computation section which is an object in a recorded code string, the amount of a level code of a special computation section which is an object, and so forth. The special computing unit 331 outputs the information of computation results to the insertion control unit 332.

The insertion control unit 332 determines whether each of the special computation sections is a section of a level code to be subjected to special processing, or a section of a level code to be subjected to normal processing, based on the information supplied from the special computing unit 331, and determines the value corresponding to the determination result as the value of a special bit.

For example, in the event that the value of the special bit is 0, this represents that the section of a level code used for obtaining the special bit thereof is a target section of normal processing at the time of demodulation. On the other hand, in the event that the value of the special bit is 1, this represents that the section of a level code used for obtaining the special bit thereof is a target section of special processing at the time of demodulation.

The content of signal processing may differ between the special processing and the normal processing. The signal processing at the time of demodulation includes EQ (equalizer) processing, PRML (Partial Response Maximum Likelihood) processing, and filtering processing using an FIR filter.

For example, the normal processing is made up of predetermined EQ processing and PRML processing (PR121), and the special processing is made up of predetermined EQ processing and PRML processing (PR1221) which is shifted by a half phase from the normal processing.

Also, the normal processing is filtering processing using an FIR filter having predetermined properties, and the special processing is filtering processing using an FIR filter having a property for enhancing high-frequency components.

For example, in the event that the recorded position of a level code of a special computation section which is an object has been determined, the insertion control unit 332 selects 1 as the value of a special bit when the recorded position of the level code thereof is in a position on the inner circumferential side of the optical disc, and selects 0 at the time of a position on the outer circumferential side. For example, the length R of the radius of the optical disc serving as the recording destination of the recorded code string is divided into two, a position on the inner side of a circle of (½) R is taken as the position on the inner circumferential side, and a position on the outer side of the circle of (½) R is taken as the position on the outer circumferential side.

Also, in the event that analysis of the run information of a level code of a special computation section which is an object has been performed, the insertion control unit 332 selects 1 as the value of a special bit when the special computation section which is an object is a section where the frequency of occurrence of 2T that is the minimum run is greater than the frequency of a threshold, and selects 0 at the time of a section where the frequency of occurrence is smaller than the frequency of the threshold.

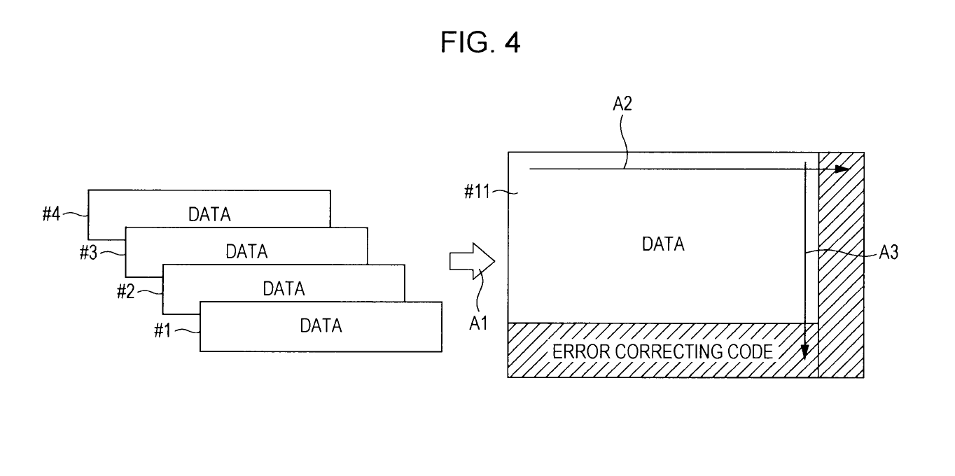

Thus, with the device on the demodulation side for playing the recorded code string generated by the data modulating device 1001, the content of signal processing is switched according to the recorded position of the channel bit string read out from the recording medium, or the occurrence frequency of 2T. The value of a special bit is switched at predetermined timing such as for each special computation section, for each FS (Frame Sync) section that is a section from a certain synchronous signal to the next synchronous signal, for each piece of data of block units described with reference to FIG. 4, or the like.

The insertion control unit 332 outputs the information of the determined value of the special bit to the special information processing control unit 317.

The DSV computing unit 341 of the DSV control unit 322 performs DSV computation using the level code from the NRZI conversion unit 314. The computation section for DSV computation is set by the control section determining unit 315.

With DSV computation, for example, the number of ones and the number of zeros with a level code of a DSV control section which is an object are counted, and information made up of difference between the number of ones and the number of zeros, and DSVs accumulated so far is created. Also, of accumulated DSVs in the event of providing a DSV bit “1” as an information bit, and accumulated DSVs in the event of providing a DSV bit “0”, a level code approximate to 0 is selected. The DSV computing unit 341 controls the information bit inserting unit 311 to insert each of 0 and 1 as a DSV bit.

The recorded code string determining unit 342 selects, of the level codes supplied from the NRZI conversion unit 314, either a level code providing 1 as a DSV bit or a level code providing 0, as a recorded code string.

The special information processing control unit 317 supplies the special bit determined by the insertion control unit 332 to the information bit inserting unit 311, thereby inserting this in a predetermined position of the input data string.

### Operation of Data Modulating Device

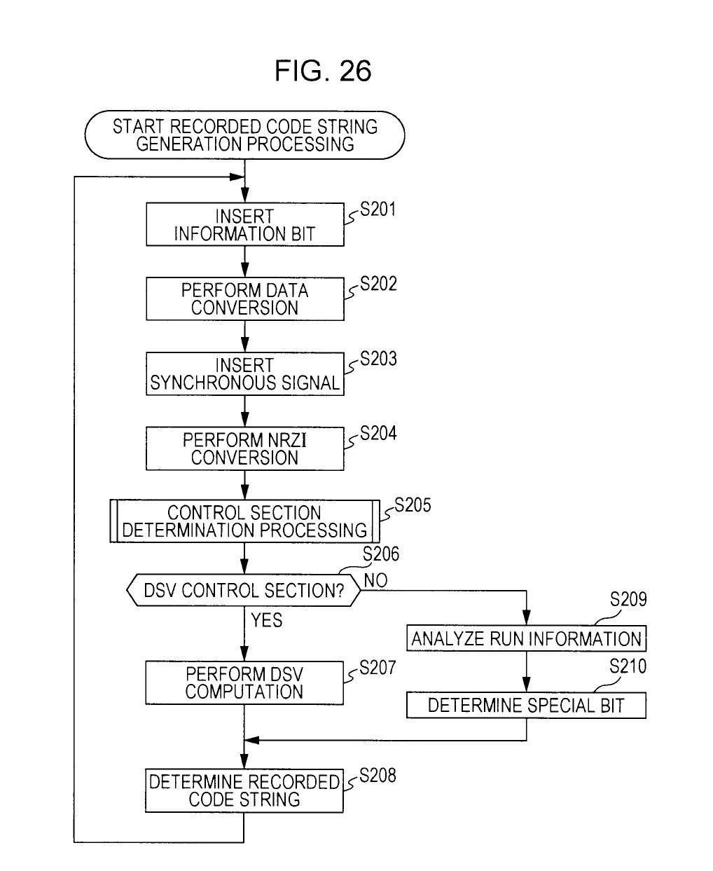

Now, the recorded code string generation processing of the data modulating device 1001 in FIG. 25 with reference to the flowchart in FIG. 26.

In step S201, the information bit insertion unit 311 inserts an information bit into the input data string. For example, the input data string is sectioned in increments of 45 bits, and immediately after the termination of one section, one special bit or DSV bit is inserted. The information bit inserting unit 311 can determine the insertion position of an information bit by counting the number of bits of the input data string.

In the event that the information bit to be inserted is a special bit, the information bit inserting unit 311 inserts the special bit in the data string in accordance with the control by the special information processing control unit 317. The insertion position of a special bit may be specified by the special information processing control unit 317.

In the event that the information bit to be inserted is the DSV bit, the information bit inserting unit 311 inserts both of a DSV bit of which the value is 1, and a DSV bit of which the value is 0. That is to say, two data strings of a data string into which a value 1 is inserted as a DSV bit, and a data string into which a value 0 is inserted as a DSV bit, are generated. The value and insertion position of a DSV bit may be specified by the DSV computing unit 341.

Though the details will be described later, a DSV bit is inserted within a DSV control section of a computation object. On the other hand, a special bit is inserted within a special computation section latter than the special computation section which is an object.

In step S202, the data conversion unit 312 converts the data string into which the information bit is inserted in accordance with the modulation table in FIG. 2. Thus, the data string is converted into a channel bit string made up of the corresponding code pattern with a data pattern in the modulation table in FIG. 2 as units.

In step S203, the synchronous signal inserting unit 313 generates a synchronous signal, and outputs to the data conversion unit 312. With the data conversion unit 312, the synchronous signal supplied from the synchronous signal inserting unit 313, and the channel bit string are synthesized, and the channel bit string into which the synchronous signal is inserted is output to the NRZI conversion unit 314.

In step S204, the NRZI conversion unit 314 performs NRZI conversion of the channel bit string supplied from the data conversion unit 312.

In step S205, the control section determining unit 315 executes control section determination processing. According to the control section determination processing, a predetermined section of the channel bit string is set as a control section. The length of the control section is variable. That is to say, no control section is set with a certain number of bits as units. The details of the control section determination processing will be described later.

In step S206, the control section determining unit 315 determines whether or not the control section set by the control section determination processing is a DSV control section. Whether the control section is a DSV control section or special computation section depends on specification by the system or user. In the event that there is a specification by the user, determination is performed based on the specification by the user.

Specifically, the user can instruct to insert a special bit instead of a DSV bit into a part or all of the positions specified as positions where a DSV bit is inserted, by the system when rigorous DSV control is unnecessary. Note that, with the present disclosure, specification by the user being prioritized over the specification by the system is not indispensable.

In the event that determination is made in step S206 that the control section is a DSV control section, in step S207 the DSV computing unit 341 performs DSV computation with the DSV control section as an object.

Two types of level code strings of a level code string obtained by converting the data string in which a value 0 is inserted as a DSV bit, and a level code string obtained by converting the data string in which a value 1 is inserted as a DSV bit are input to the DSV computing unit 341. The DSV computing unit 341 computes a value obtained by adding a DSV in the DSV control section of one of the level code strings to the accumulated DSV, and a value obtained by adding a DSV in the DSV control section of the other level code string to the accumulated DSV, and outputs the computation result information to the recorded code string determining unit 342.

In step S208, the recorded code string determining unit 342 selects one of the level code string obtained by converting the data string in which a value 0 is inserted as a DSV bit, and the level code string obtained by converting the data string in which a value 1 is inserted as a DSV bit, based on the computation result by the DSV computing unit 341. The recorded code string determining unit 342 outputs the selected level code string as a recorded code string.

On the other hand, in the event that determination is made in step S206 that the control section is not a DSV control section but a special computation section, in step S209 the special computing unit 331 analyzes the run information of the level code of each of the special computation sections.

In step S210, the insertion control unit 332 determines the value of a special bit. With this example, the value of a special bit is determined based on the analysis results of the run information. The information of the value of a special bit is supplied to the information bit inserting unit 311 via the special information processing control unit 317.

After a special bit is determined in step S210, in step S208 a recorded code string is determined by the recorded code string determining unit 342. In this case, the recorded code string determining unit 342 selects the level code of the special computation section supplied from the NRZI conversion unit 314 as a recorded code string without change, and outputs this.

As described above, with the modulation table in FIG. 2, parity is stored with relationship between data before conversion, and codes after conversion. Accordingly, even if the value of an information bit (i.e., 1 or 0) to be inserted into the data string is determined based on the results computed with the channel bit, DSV control can be performed.

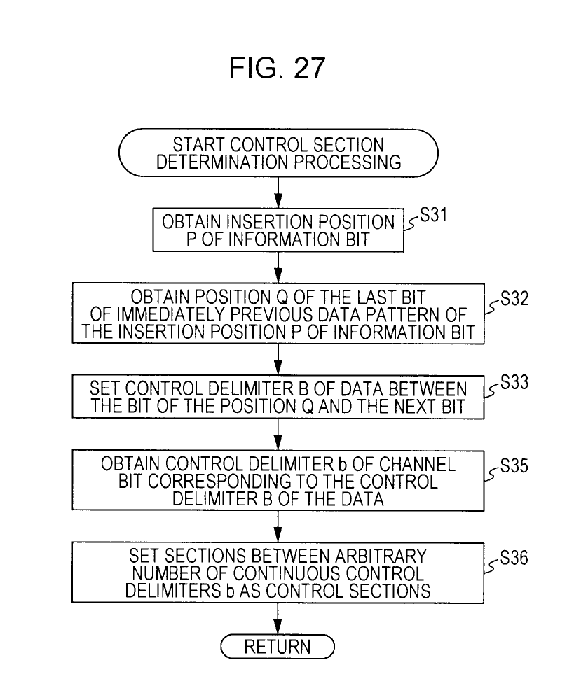

Next, the control section determination processing to be performed in step S205 in FIG. 26 will be described with reference to the flowchart in FIG. 27.

In step S31, the control section determining unit 315 obtains a position P that is the insertion position of the information bit. As described above, with this example, one information bit is inserted for 45 pieces of data, and accordingly, the position P is obtained by counting the number of bits of the data of a conversion object.

In step S32, the control section determining unit 315 obtains the position Q of the last bit of the immediately previous data pattern of the insertion position P of the information bit. The immediately previous data pattern of the insertion position P of the information bit is taken as a data pattern including no information bit.

In step S33, the control section determining unit 315 sets a data delimiter B between the bit in the position Q determined in step S32, and the next bit of the bit in the position Q. That is to say, with the information bit inserted into the data as a reference, a control delimiter B of the data is set between the last bit of the immediately pervious data pattern of the information bit, and the next bit thereof.

In step S35, the control section determining unit 315 obtains a control section b of the channel bit corresponding to the control delimiter B of the data.

In step S36, the control section determining unit 315 sets continuous sections between an arbitrary number of control delimiters b as control sections.

### Second Embodiment

### Configuration of Data Demodulating Device

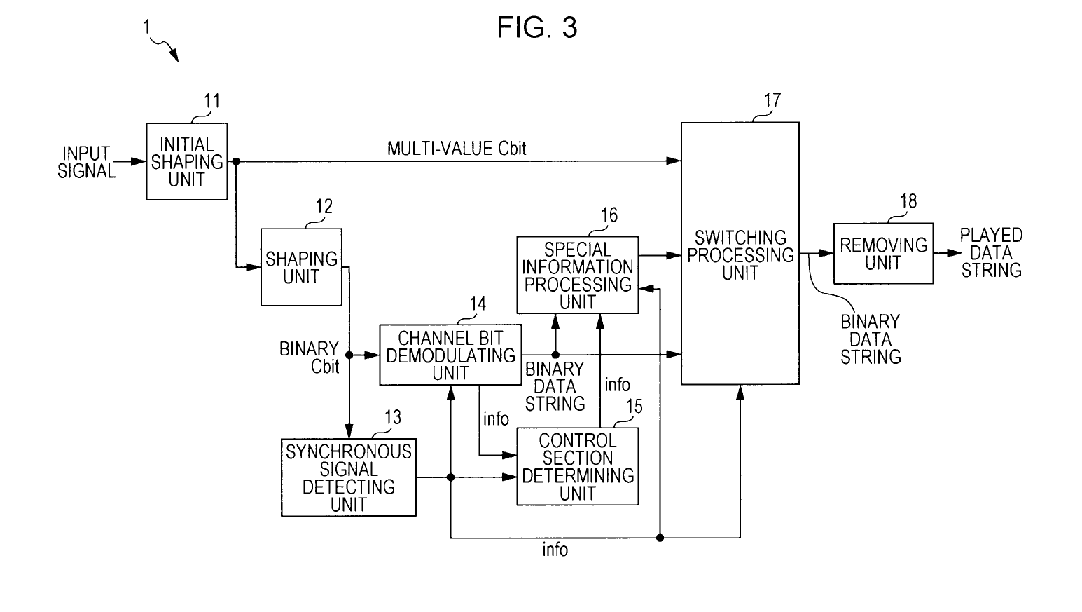

FIG. 3 is a block diagram illustrating a basic configuration example of a data demodulating device according to an embodiment of the present disclosure. As illustrated in FIG. 3, the data demodulating device 1 is configured of an initial shaping unit 11, a shaping unit 12, a synchronous signal detecting unit 13, a channel bit demodulating unit 14, a control section determining unit 15, a special information processing unit 16, a switching processing unit 17, and a removing unit 18.

A signal obtained by playing a recording medium such as a Blu-ray Disc (registered trademark) or the like is input to the initial shaping unit 11. A signal transmitted via a network such as the Internet, a LAN (Local Area Network) or the like may be input to the initial shaping unit 11.

The initial shaping unit 11 performs initial shaping of an input signal. The initial shaping includes, for example, small-gain EQ (equalizer) processing, A/D conversion processing of a signal obtained by the EQ processing, and so forth. An arrangement may be made wherein sampling is performed with a sampling frequency equal to or greater than a stipulated value, and after the EQ processing is performed, processing for subjecting digital PLL (Phase Lock Loop) is performed as the initial shaping. The initial shaping unit 11 outputs a multi-value channel bit string that is a signal obtained by the initial shaping to the shaping unit 12 and the switching processing unit 17.

The shaping unit 12 performs shaping processing including, for example, the EQ processing, PRML (Partial Response Maximum Likelihood) processing, and so forth with the channel bit string supplied from the initial shaping unit 11 as an object. Also, the shaping unit 12 converts the signal obtained by the shaping processing into a channel bit string made up of a binary of 0 or 1.

Hereafter, the shaping processing performed by the shaping unit 12 including processing such as the EQ processing, PRML processing, and so forth will also be referred to as first shaping processing as appropriate. Second shaping processing is performed at the switching processing unit 17 separately from the first shaping processing by the shaping unit 12 as appropriate.

The shaping unit 12 generates, after performing the first shaping processing, a channel bit string by performing binary conversion for comparing the signal with a predetermined threshold, or binary conversion owing to the maximum likelihood detection according to a technique such as the Viterbi algorithm or the like. The shaping unit 12 outputs the generated channel bit string to the synchronous signal detecting unit 13 and the channel bit demodulating unit 14. The channel bit string generated by the shaping unit 12 is also supplied to the special information processing unit 16 as appropriate.

The synchronous signal detecting unit 13 detects a synchronous signal inserted into the channel bit string supplied from the shaping unit 12 with a predetermined interval by detecting the 24-bit synchronous pattern (#01 001 000 000 001 000 000 001) in FIG. 2. The synchronous signal detecting unit 13 supplies information representing the detection timing of the synchronous signal to the channel bit demodulating unit 14, control section determining unit 15, special information processing unit 16, and switching processing unit 17. Synchronization of processing at each unit is secured based on the synchronous signal detected by the synchronous signal detecting unit 13.

The recorded code string input to the data demodulating device 1 as an input signal by a recording medium being played is generated by inserting the information bit in a predetermined position of the data string. Specifically, for example, the data string is generated by inserting one information bit for each 45 pieces of data.

The information bit inserted with a certain interval are usually a DSV bit for DSV control, but all or a part thereof are replaced with a special bit as appropriate. It is arbitrary to set what kind of bit as a special bit, but for example, a bit for specifying the content of signal processing at the time of demodulation may be employed. One bit to be inserted with a certain interval as the information bit may be a DSV bit or may be a special bit.

The data modulating device 1001 is configured so as to dispose identification information that is information representing whether or not a special bit is included within the synchronous signal.

For example, in the event that the synchronous signal is made up of 30 bits obtained by adding 6-bit additional information to the 24-bit synchronous pattern, the 6-bit additional information can be employed as identification information representing whether or not a special bit is included in the data string. The synchronous signal detecting unit 13 also detects identification information included in the synchronous signal. The identification information detected by the synchronous signal detecting unit 13 is supplied to the control section determining unit 15, special information processing unit 16, and switching processing unit 17.

According to such 6-bit additional information, for example, the following structure made up of DSV bits and special bits arrayed in a complicated sequence can be realized.

DSV bit-special bit-special bit-DSV bit-special bit-special bit-DSV bit- and so on

In this case, a rule is determined on the encoder (data modulating device) side and the decoder (data demodulating device) side regarding alignment of DSV bits and special bits.

The channel bit demodulating unit 14 demodulates the channel bit string supplied from the shaping unit 12 in accordance with the demodulation table in FIG. 2 having a variable-length structure to output a binary data string. At this time, the channel bit string from the shaping unit 12 is converted into an edge code by subjecting the level code to inverse NRZI conversion as appropriate. The channel bit demodulating unit 14 outputs the data string obtained by demodulation to the special information processing unit 16 and the switching unit 17. Also, the channel bit demodulating unit 14 outputs information relating to the position of each data making up the data string to the control section determining unit 15.

The control section determining unit 15 detects a delimiter of data conversion based on the information supplied from the channel bit demodulating unit 14, and determines the position of a control section of the data string based on the detected delimiter, and whether the control section thereof is a DSV control section or special computation section. The demodulation table in FIG. 2 is a table having a variable-length structure, and accordingly, the control section also has variable length. The control section determining unit 15 outputs the information of the determined control section to the special information processing unit 16.

The special information processing unit 16 extracts a special bit inserted into the data string supplied from the channel bit demodulating unit 14 with the position of the control section determined by the control section determining unit 15 as a reference. The special information processing unit 16 outputs the value of the extracted special bit, and information representing a section that the special bit takes as an object to the switching processing unit 17. In the event that the identification information is included in the synchronous signal, the processing by the special information processing unit 16 may be performed only when the value of the identification information supplied from the synchronous signal detecting unit 13 represents that a special bit is included.

In the event that a special bit is included in the data string, the switching processing unit 17 subjects the channel bit string supplied from the initial shaping unit 11 to the second shaping processing according to the information supplied from the special information processing unit 16. Also, the switching processing unit 17 demodulates the channel bit string obtained by the second shaping processing to generate a binary data string, and outputs to the removing unit 18.

The content of the second shaping processing to be performed by the switching processing unit 17 can be switched in the event that the value of the special bit is 0, and in the event that the value of the special bit is 1. For example, in the event that the value of the special bit is 0, this represents that the section that the special bit thereof takes as an object is a target section of the normal processing. On the other hand, in the event that the value of the special bit is 1, this represents that the section used for obtaining the special bit thereof is a target section of the special processing.

For example, the normal processing performed as the second processing is signal processing including predetermined EQ processing and PRML processing (PR121), and the special processing is signal processing including predetermined EQ processing and PRML processing (PR1221) which is shifted by a half phase from the normal processing.

Also, in the event that filtering processing using an FIR filter is performed as signal processing, the properties of the FIR filter used for the filtering processing may be switched between the normal processing and the special processing. For example, with the special processing, there is employed an FIR filter having a property for further enhancing high-frequency components as compared to the FIR filter used for the normal processing.

With the data modulating device 1001, 1 is selected as the value of a special bit when the recorded position of the level code of the section used to obtain the special bit is in a position on the inner circumferential side of the optical disc, and 0 is selected at the time of a position on the outer circumferential side. For example, the length R of the radius of the optical disc serving as the recording destination of the recorded code string is divided into two, a position on the inner side of a circle of (½) R is taken as the position on the inner circumferential side, and a position on the outer side of the circle of (½) R is taken as the position on the outer circumferential side.

Also, in the event that analysis of the run information of a level code of the section used for obtaining the special bit has been performed, 1 is selected as the value of the special bit when the target section is a section where the frequency of occurrence of 2T that is the minimum run is greater than the frequency of a threshold, and 0 is selected at the time of a section where the frequency of occurrence is smaller than the frequency of the threshold.

Thus, with the data demodulating device 1 for processing the recorded code string generated by the data modulating device 1001, the content of signal processing is switched according to the recorded position of data read out from the recording medium, or the occurrence frequency of 2T. The value of a special bit is switched at predetermined timing such as for each special computation section, for each FS (Frame Sync) section that is a section from a certain synchronous signal to the next synchronous signal, for each piece of data of block units described later with reference to FIG. 4, or the like.

In the event that no special bit is included in the data string, the switching processing unit 17 outputs the binary data string supplied from the channel bit demodulating unit 14 to the removing unit 18.

The removing unit 18 removes redundant bits inserted into the data string supplied from the switching processing unit 17. Examples of the redundant bits include a synchronous signal, a DSV bit, and a special bit. The removing unit 18 outputs the data string from which the redundant bits are removed, as a playback data string. Though not illustrated in the drawing, there is provided a timing control unit configured to control timing by generating a timing signal and supplying to each unit.

FIG. 4 is a diagram illustrating an example of the data string input to the data modulating device 1001 as the data of a modulation object. The signal obtained by modulating the data string shown in FIG. 4 at the data modulating device 1001 is input to the data demodulating device 1, and is demodulated at the data demodulating device 1, and accordingly, the data string shown in FIG. 4 is also the playback data string output from the data demodulating device 1 as the data of demodulation results.

For example, a data block is structured by a plurality of the data of predetermined data amount (user data) being collected as a block, and an ECC (Error-Correcting Code) is added to the data block.

With the example in FIG. 4, a data block #11 is structured such as illustrated at the tip of a white arrow Al by data #1 through #4 being arrayed in the sequence of processing objects. Also, as illustrated with an arrow A2 in the horizontal direction, and an arrow A3 in the vertical direction, of data making up the data block #11, an ECC is added to each of data arrayed in the horizontal direction, and data arrayed in the vertical direction.

Data of block units such as shown on the right side of FIG. 4 made up of a data block and an ECC is input to the data modulating device 1001 as an input data string. With the data demodulating device 1, the data of block units shown on the right side of FIG. 4 is obtained as playback data by demodulating the channel bit string obtained by modulating the data of block units.

### Operation of Data Demodulating Device

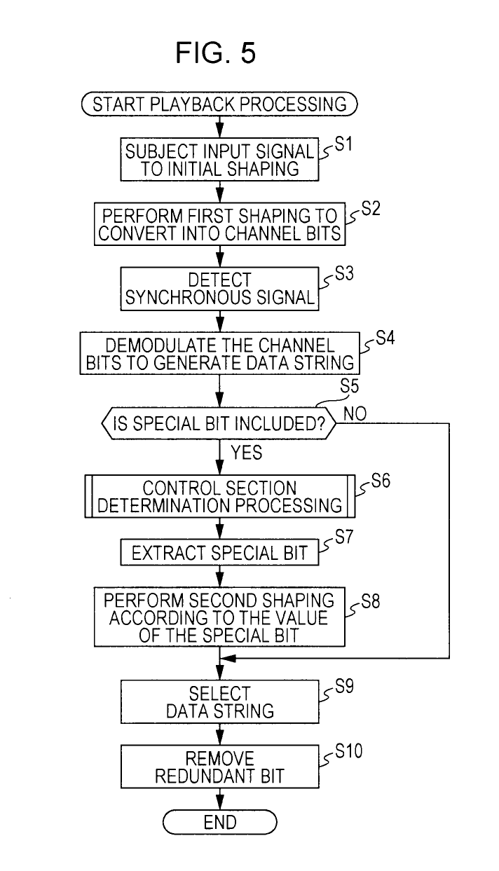

The playback processing of the data demodulating device 1 in FIG. 3 will be described with reference to the flowchart in FIG. 5.

In step S1, the initial shaping unit 11 performs initial shaping of an input signal.

In step S2, the shaping unit 12 performs the first shaping processing as to the input signal subjected to the initial shaping, and further performs binary conversion, thereby generating a channel bit string.

In step S3, the synchronous signal detecting unit 13 detects a synchronous signal from the channel bit string generated by the shaping unit 12. Also, the synchronous signal detecting unit 13 detects the identification information included in the synchronous signal. With this example, the identification information is included in the synchronous signal. Determination can be made from the identification information whether or not the data string includes a special bit.

In step S4, the channel bit demodulating unit 14 demodulates the channel bit string generated by the shaping unit 12 to output a binary data string.

In step S5, the synchronous signal detecting unit 13 determines based on the detected identification information whether or not a special bit is included in the data string.

In the event that determination is made in step S5 that a special bit is included, in step S6 the control section determining unit 15 executes the control section determination processing. According to the control section determination processing, a special computation section is set to the data string. The details of the control section determination processing will be described later.

In step S7, the special information processing unit 16 extracts the special bit from the data string, and outputs the value of the special bit, and information representing a section that the special bit takes as an object, to the switching processing unit 17.

In step S8, the switching processing unit 17 performs the second shaping processing according to the value of the special bit as to the channel bit string supplied from the initial shaping unit 11, and performs demodulation processing as to the channel bit string subjected to the second shaping processing, thereby generating a data string.

In the event that determination is made in step S5 that no special bit is included, the processing in steps S6 through S8 is skipped.

In step S9, the switching processing unit 17 selects a data string. Specifically, in the event that a special bit is included in the data string, the switching processing unit 17 performs the second shaping processing and demodulation processing, thereby selecting the self-generated data string. On the other hand, in the event that the processing in steps S6 through S8 has been skipped since no special bit is included in the data string, the switching processing unit 17 selects the data string supplied from the channel bit demodulating unit 14.

In step S10, the removing unit 18 removes redundant bits from the data string selected by the switching processing unit 17, and outputs the data string from which the redundant bits are removed, as a playback data string. Thereafter, the processing is ended.

According to the above processing, in the event that a special bit is included in the data string, signal processing according to the value of the special bit is performed at the data demodulating device 1.

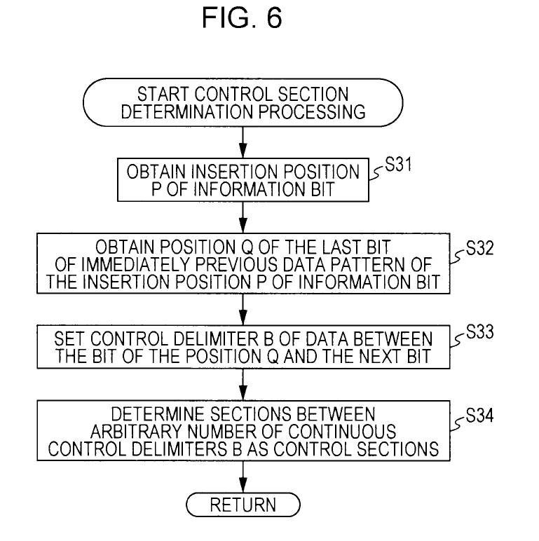

Next, the control section determination processing performed in step S6 in FIG. 5 will be described with reference to the flowchart in FIG. 6.

In step S31, the control section determining unit 15 obtains a position P that is the insertion position of an information bit. With this example, one information bit is inserted for each 45 pieces of data, and accordingly, the position P is obtained by counting the number of bits of the data of a conversion object.

In step S32, the control section determining unit 15 obtains the position Q of the last bit of the immediately previous data pattern of the insertion position P of the information bit. The immediately previous data pattern of the insertion position P of the information bit is taken as a data pattern including no information bit.

In step S33, the control section determining unit 15 sets a control delimiter B of the data between the bit in the position Q determined in step S32, and the next bit of the bit in the position Q. That is to say, the control delimiter B is set between the last bit of the immediately previous data pattern of the information bit, and the next bit thereof with the information bit inserted into the data as a reference.

In step S34, the control section determining unit 15 determines continuous sections between arbitrary number of control delimiters B as control sections. The processing then returns to step S6 in FIG. 5, and thereafter, the subsequent processing is performed.

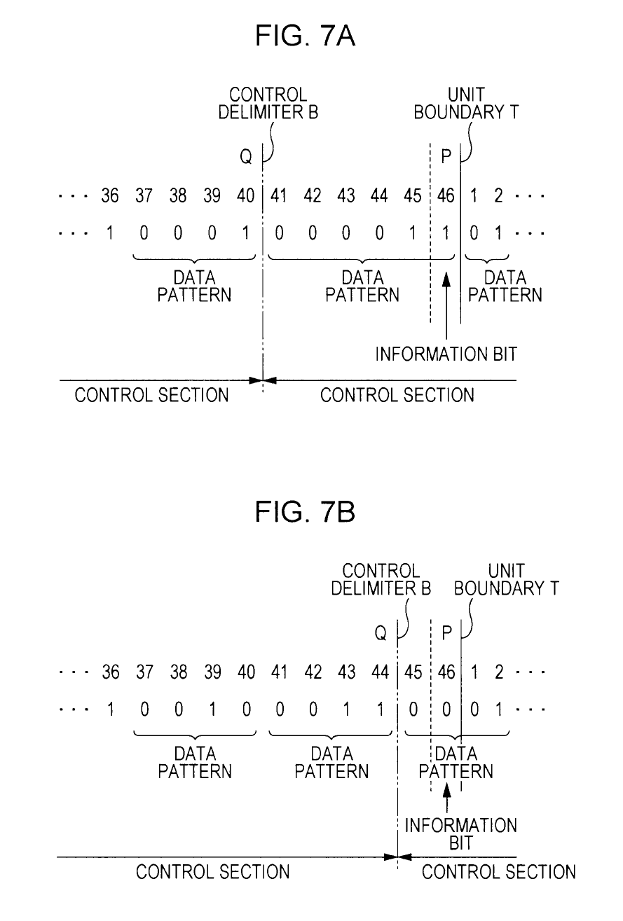

FIGS. 7A and 7B are diagrams illustrating an example of control sections. Operation for inserting one information bit for each 45 pieces of data is repeated. Specifically, processing for dividing the data string with 45 pieces of data (45 bits) as units, and inserting one information bit immediately after 45 pieces of data (the first bit through 45'th bit) is repeated at the data modulating device 1001. Accordingly, the data after insertion of an information bit becomes, as shown in FIGS. 7A and 7B, a data string in increments of 46 bits where an information bit is inserted in a position P that is the position of the 46'th data following the 45 pieces of data, and a unit boundary T is taken as a delimiter.

As shown in the demodulation table in FIG. 2, the number of bits of a data pattern is one of 2, 4, 6, and 8. In the event of the example in FIG. 7A, 6 bits of the 41st through the 46'th bits (000011) make up a data pattern. However, this pattern includes the information bit of the 46'th bit, and accordingly, this pattern is excluded from the immediately previous data pattern in the insertion position P. The 4-bit data pattern of the 37'th through 40'th bits (0001) prior to the data pattern (000011) becomes the immediately previous data pattern in the insertion position P. Accordingly, the position Q of the last bit of the immediately previous data pattern in the insertion position P becomes the position of the 40'th bit.

In the event of the example in FIG. 7A, the control delimiter B of the data is set between the 40'th bit in the position Q and the 41st bit that is the next bit thereof.

On the other hand, in the event of the example in FIG. 7B, the 45'th bit and 46'th bit make up a data pattern (0001) along with the data of the first bit and second bit (01) in the next increments. Accordingly, the data pattern (0001) is not the immediately previous data pattern in the position P. Four bits of the 41st bit through 44'th bit (0011) prior thereto are the immediately previous data pattern in the insertion position P. Accordingly, the position Q of the last bit of the immediately previous data pattern in the insertion position P becomes the position of the 44'th bit that is the last bit of the data pattern (0011).

In the event of the example in FIG. 7B, the control delimiter B of the data is set between the 44'th bit in the position Q and the 45'th bit that is the next bit thereof.

The control sections thus set are taken as a special computation section or a DSV control section. The special computation section is a section set within the data string, and is a section where signal processing according to the value of a special bit inserted with the section thereof as an object is performed. The DSV control section is a section set within the data string, and is a section where DSV control is performed based on a DSV bit inserted with the section thereof as an object.

Whether each control section is taken as either a special computation section or a DSV control section is determined with a predetermine rule beforehand such that DSV control sections and special computation sections are alternately arrayed. The control section determining unit 15 can determine, based on the rule thereof, whether each control section is taken as either a special computation section or a DSV control section.

Only one bit is included in a DSV control section as a DSV bit. Thus, DSV control can suitably be performed.

Note that s DSV control section may be a fixed value. In this case, for example, a position prior to the position of an information bit by 10 pieces of data is specified as the control delimiter B of each section. Specifically, the control delimiter B is set immediately after a bit prior to an information bit by a certain number of bits with the information bit inserted in the data as a reference. This is variable length conversion, and accordingly, shifting after conversion occurs, but DSV control can be performed so as to include fixed information based on the channel bits of a delimiter and thereafter in the next section.

Also, one information bit may be inserted for each 91 pieces of data, for example. The insertion interval is arbitrary.

### Example of Control Sections

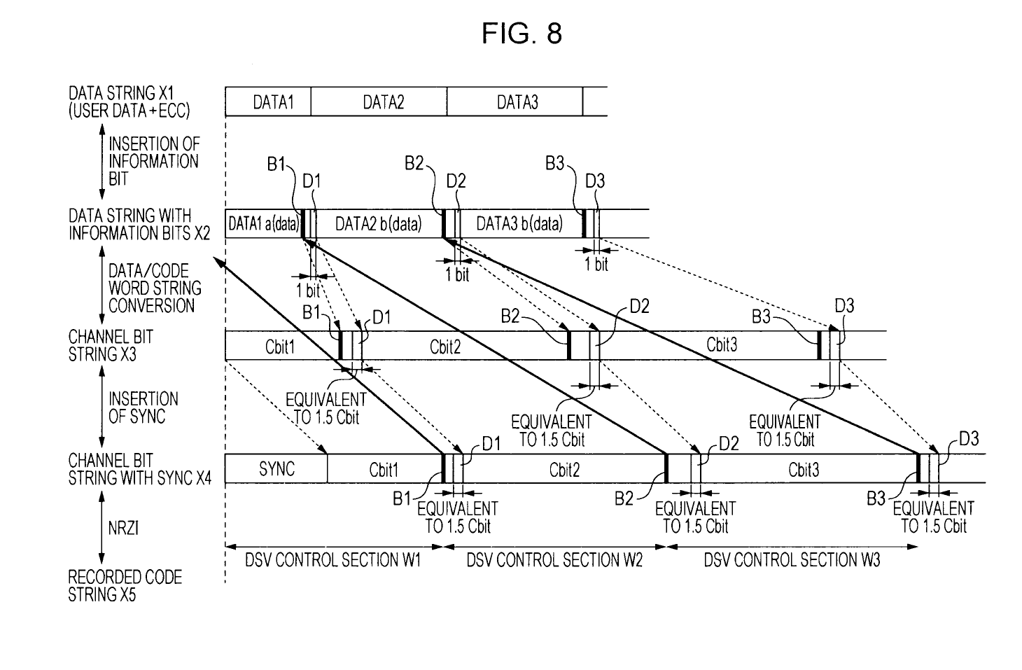

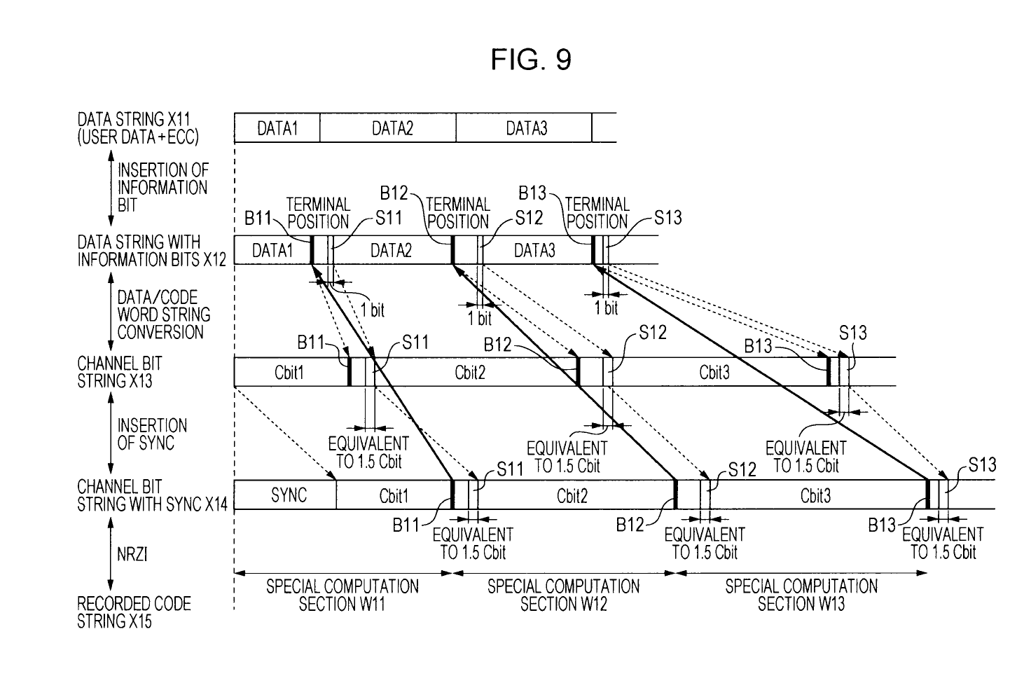

FIG. 8 is a diagram illustrating an example of control sections made up of DSV control sections. Each stage in FIG. 8 represents process wherein a recorded code string to be input to the data demodulating device 1 is generated at the data modulating device 1001. The signal of the recorded code string generated as illustrated in FIG. 8 is supplied to the data demodulating device 1 as an input signal. The signal of the recorded code string generated as illustrated in FIGS. 9 through 13 may be input to the data demodulating device 1.

A data string X1 on the first stage in FIG. 8 is a data string before conversion. The data string X1 includes, as described above, user data and an ECC. One information bit is inserted into the data string X1 with a certain interval such as a 45-bit interval, whereby a data string with information bits X2 as shown on the second stage is generated.

The head section of the data string X1 is set to a section shorter than other sections assuming that a synchronous signal (SYNC) is inserted thereinto. Let us say that the lengths of DSV control sections (DATA1, DATA2, and DATA3) within the data string X2 are a, b, and b, respectively. The length Cbit of DSV control sections (DATA1, DATA2, and DATA3) of a channel bit string X3 on the third stage to be generated by modulation using a modulation table of a conversion rate m:n=2:3 becomes (a×3/2)=1.5a or (b×3/2)=1.5b,

A channel bit string with a SYNC X4 as illustrated in the fourth stage is generated by inserting a synchronous signal (SYNC) into the channel bit string X3. A synchronous signal block is inserted into a predetermined position (the head prior to DATA1 in the case of the example in FIG. 8) of the channel bit string with a SYNC X4 in a channel bit format. If we say that the number of channel bits of the synchronous signal is c, the relationship of the following Expression (1) is held.

1.5a+c=1.5b (1)

Thus, even with a format including the synchronous signal, DSV control is performed with an equal interval.

A DSV bit that is 1-bit data is equivalent to 1.5 channel bit of channel bits. That is to say, the DSV bit inserted into the data string by one bit increases just for a conversion rate worth with channel bits as follows.

1 bit×n/m=1×3/2=1.5 channel bit (2)

The control delimiter B is near a unit boundary T that is a boundary of units where information bits (DSV bit D in the case of FIG. 8) is inserted, but is located in a position different therefrom.

As shown on the fourth stage in FIG. 8, for example, continuous control delimiters B are selected, a section between the selected control delimiters B is taken as a DSV control section. In the event of the example in FIG. 8, a section between a control delimiter B0 (not shown) and the next control delimiter B1 is taken as a DSV control section W1, and a section between the control delimiter B1 and the next control delimiter B2 is taken as a DSV control section W2. Also, a section between the control delimiter B2 and the next control delimiter B3 is taken as a DSV control section W3.

A DSV bit is disposed within a DSV control section serving as a computation object. For example, a DSV obtained as a result of DSV computation with the DSV control section W2 as an object is disposed within the DSV control section W2 as a DSV bit D1. Similarly, a DSV obtained as a result of DSV computation with the DSV control section W3 as an object is disposed within the DSV control section W3 as a DSV bit D2.

The number of DSV bits included in one DSV control section is only one. Thus, DSV control can suitably be performed.

As illustrated downward in FIG. 8, a channel bit string with a SYNC X4 is subjected to NRZI conversion, whereby a recorded code string X5 is generated. The signal of the recorded code string X5 is input to the data demodulating device 1 as an input signal.

With the data demodulating device 1, a channel bit string with a SYNC X4 is generated from the recorded code string X5 by the shaping unit 12. Also, a synchronous signal is detected from the channel bit string with a SYNC X4 by the synchronous signal detecting unit 13.

A data string with information bits X2 (in reality, the synchronous signal is also added) is generated from the channel bit string with a SYNC X4 by the channel bit demodulating unit 14 in accordance with the demodulation table in FIG. 2. Also, a special computation section W is determined by the control section determining unit 15, and the information of the special computation section W is supplied to the special information processing unit 16.

With this example, since no special bit is included in the data string, the processing based on special bits is not performed at the special information processing unit 16 and the switching processing unit 17, and redundant bits such as a synchronous signal, a DSV bit D, and so forth are removed from the data string with information bits X2 by the removing unit 18, and a data string X1 is generated. This becomes a playback data string.

FIG. 9 is a diagram illustrating an example of control sections made up of special computation sections. With the example in FIG. 9, all of the control sections are set to special computation sections. All of information bits to be inserted into each control section become special bits. Description redundant with description in FIG. 8 will be omitted as appropriate.

As shown on the fourth stage in FIG. 9, a section between a certain control delimiter B and the next control delimiter B is taken as a special computation section W. In the event of the example in FIG. 9, a section between a control section B10 (not shown) and the next control section B11 is taken as a special computation section W11, and a section between the control section B11 and the next control section B12 is taken as a special computation section W12. Also, a section between the control section B12 and the next control section B13 is taken as a special computation section W13.

A special bit is disposed outside a special computation section which is an object. For example, the special bit with the special computation section W11 as an object is taken as a special bit S11, and is disposed outside the special computation section W11, within the special computation section W12 thereafter. Similarly, the special bit with the special computation section W12 as an object is taken as a special bit S12, and is disposed outside the special computation section W12, within the special computation section W13 thereafter.

As illustrated downward in FIG. 9, a channel bit string with a SYNC X14 is subjected to NRZI conversion, whereby a recorded code string X15 is generated. The signal of the recorded code string X15 is input to the data demodulating device 1 as an input signal.

With the data demodulating device 1, a channel bit string with a SYNC X14 is generated from the recorded code string X15 by the shaping unit 12. Also, a synchronous signal is detected from the channel bit string with a SYNC X14 by the synchronous signal detecting unit 13.

A data string with information bits X12 is generated from the channel bit string with a SYNC X14 by the channel bit demodulating unit 14 in accordance with the demodulation table in FIG. 2. Also, a special computation section W is determined by the control section determining unit 15, and the information of the special computation section W is supplied to the special information processing unit 16. With the special information processing unit 16, a special bit is extracted from the data string with information bits X12.

With the switching processing unit 17, signal processing is performed according to the value of the special bit, and a data string with information bits X12 is generated by demodulating the channel bit string obtained by the signal processing. Redundant bits such as a synchronous signal, a special bit S, and so forth are removed from the data string with information bits X2 by the removing unit 18, whereby a data string X1 is generated.

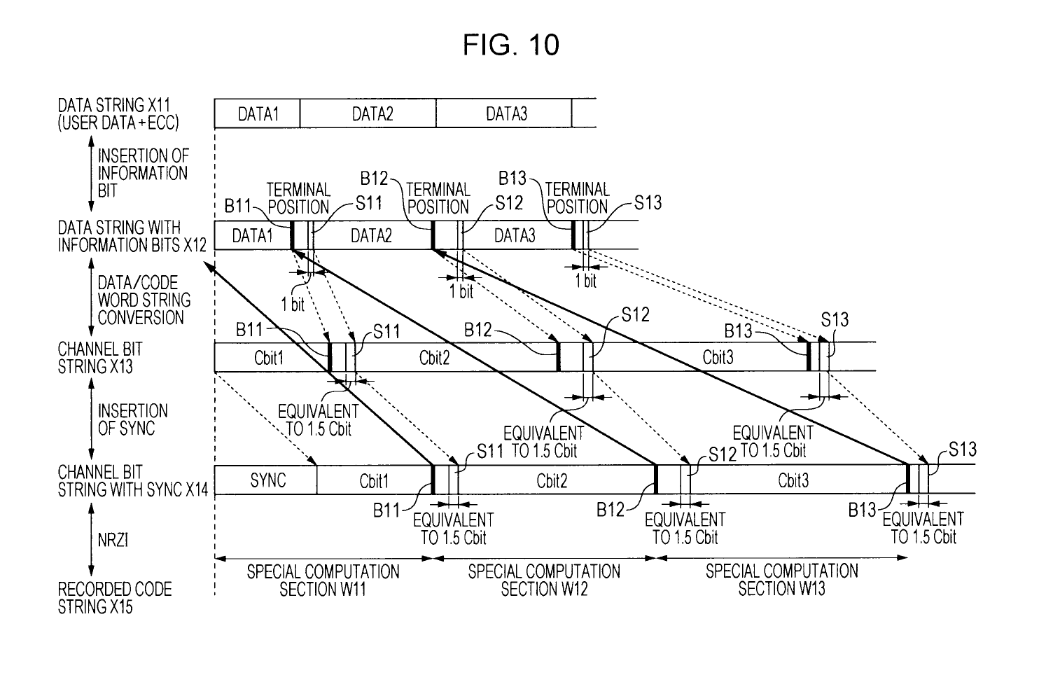

FIG. 10 is a diagram illustrating another example of control sections made up of special computation sections.

With the example in FIG. 10, all of the control sections are set to special computation sections. All of information bits to be inserted into each control section become special bits. With the example in FIG. 9, a special bit is disposed outside a special computation section which is an object, but with the example in FIG. 10, a special bit is disposed within a special computation section which is an object. Description redundant with description in FIG. 9 will be omitted as appropriate.

Specifically, as shown on the fourth stage in FIG. 10, the special bit with the special computation section W12 as an object is disposed within the special computation section W12 as a special bit S11. Similarly, the special bit with the special computation section W13 as an object is disposed within the special computation section W13 as a special bit S12.

As described above, the insertion position of a special bit may be a position within a special computation section which is an object, or may be a position outside a section.

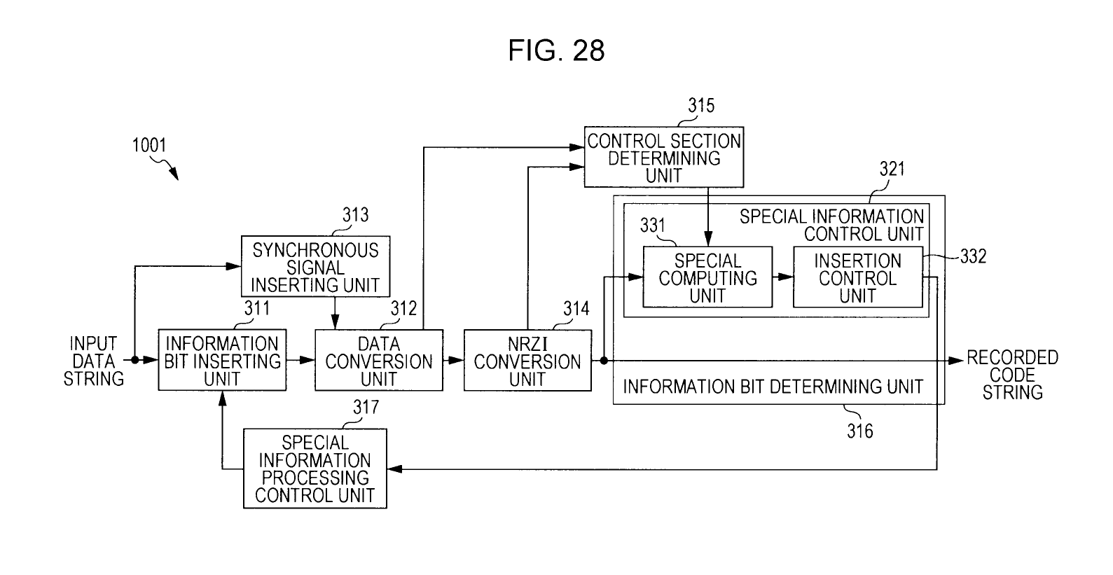

As illustrated in FIG. 9 or 10, the configuration of the data modulating device 1001 for generating a recorded code string into which a special bit alone is inserted may be a configuration as illustrated in FIG. 28. The configuration of the data modulating device 1001 illustrated in FIG. 28 is a configuration in which the DSV control unit 322 in FIG. 25 is omitted. The channel bit string subjected to NRZI conversion at the NRZI conversion unit 314 is externally output as a recorded code string without change, and also supplied to the special computing unit 331, and used for determining the value of a special bit.

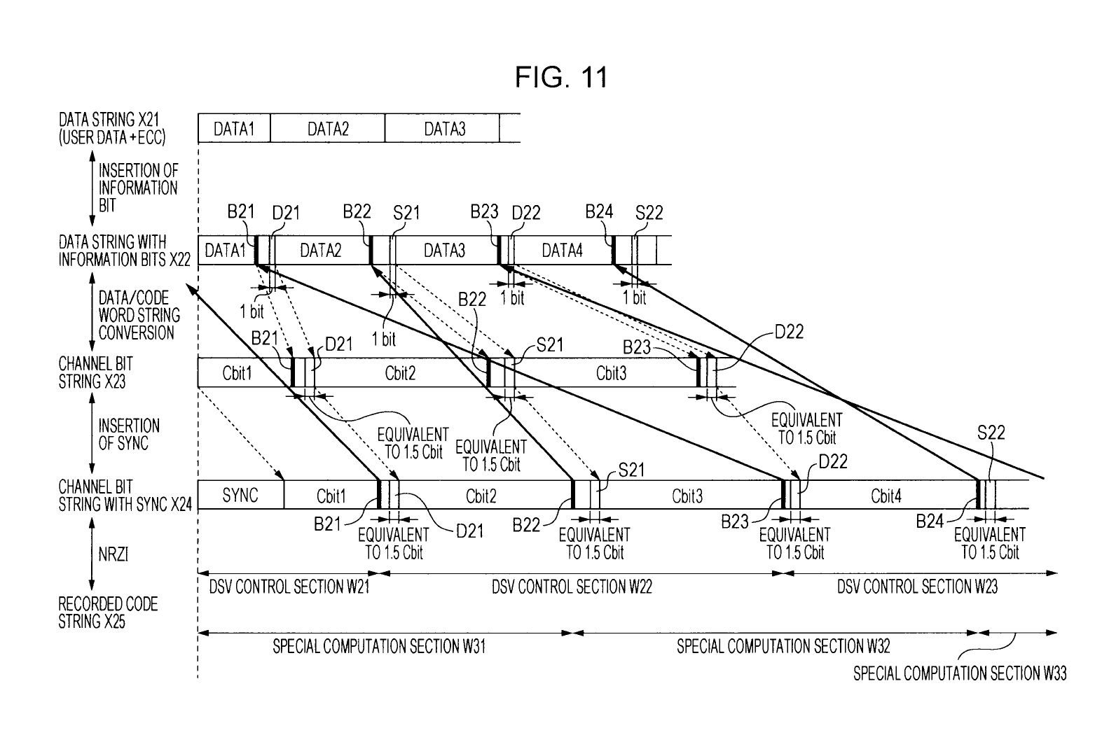

FIG. 11 is a diagram illustrating an example of control sections made up of DSV control sections and special computation sections. With the example in FIG. 11, of information bits, a part thereof are replaced with special bits, and the rest thereof is kept as a DSV bit.

For example, continuous control delimiters B are selected every other piece, and a section between the selected control delimiters B is taken as a DSV control section. Also, control delimiters B different from the control delimiters B selected as DSV control sections are selected every other pieces, and a section between the selected control delimiters B is taken as a special computation section.

With the example in FIG. 11, as shown on the fourth stage, a section between a control delimiter B21 and a control delimiter B23 skipping a control delimiter B22 is taken as a DSV control section W22, and a section between the control delimiter B23 and a control delimiter B25 (not shown) skipping a control delimiter B24 is taken as a DSV control section W23.

Also, a section between a control delimiter B20 (not shown) and the control delimiter B22 skipping the control delimiter B21 is taken as a DSV control section W31, and a section between the control delimiter B22 and the control delimiter B24 skipping the control delimiter B23 is taken as a DSV control section W32.

A DSV bit is disposed within a DSV control section serving as a computation object. For example, a DSV obtained as a result of DSV computation with the DSV control section W22 as an object is disposed within the DSV control section W22 as a DSV bit D21. Similarly, a DSV obtained as a result of DSV computation with the DSV control section W23 as an object is disposed within the DSV control section W23 as a DSV bit D22.

On the other hand, a special bit is disposed outside a special computation section which is an object. For example, the special bit with the special computation section W31 as an object is taken as a special bit S21, and is disposed outside the special computation section W31, within the special computation section W32 thereafter. Similarly, the special bit with the special computation section W32 as an object is taken as a special bit S22, and is disposed outside the special computation section W32, within the special computation section W33 thereafter.

With the example in FIG. 11, a DSV control section and a special computation section are set so as not to be overlapped. As illustrated downward in FIG. 11, a channel bit string with a SYNC X24 is subjected to NRZI conversion, whereby a recorded code string X25 is generated. The signal of the recorded code string X25 is input to the data demodulating device 1 as an input signal.

With the data demodulating device 1, a channel bit string with a SYNC X24 is generated from the recorded code string X25 by the shaping unit 12. Also, a synchronous signal is detected from the channel bit string with a SYNC X24 by the synchronous signal detecting unit 13.

A data string with information bits X22 is generated from the channel bit string with a SYNC X24 by the channel bit demodulating unit 14 in accordance with the demodulation table in FIG. 2. Also, a special computation section W and a DSV control section W are determined by the control section determining unit 15, and the information of the special computation section W is supplied to the special information processing unit 16. With the special information processing unit 16, a special bit is extracted from the data string with information bits X22.

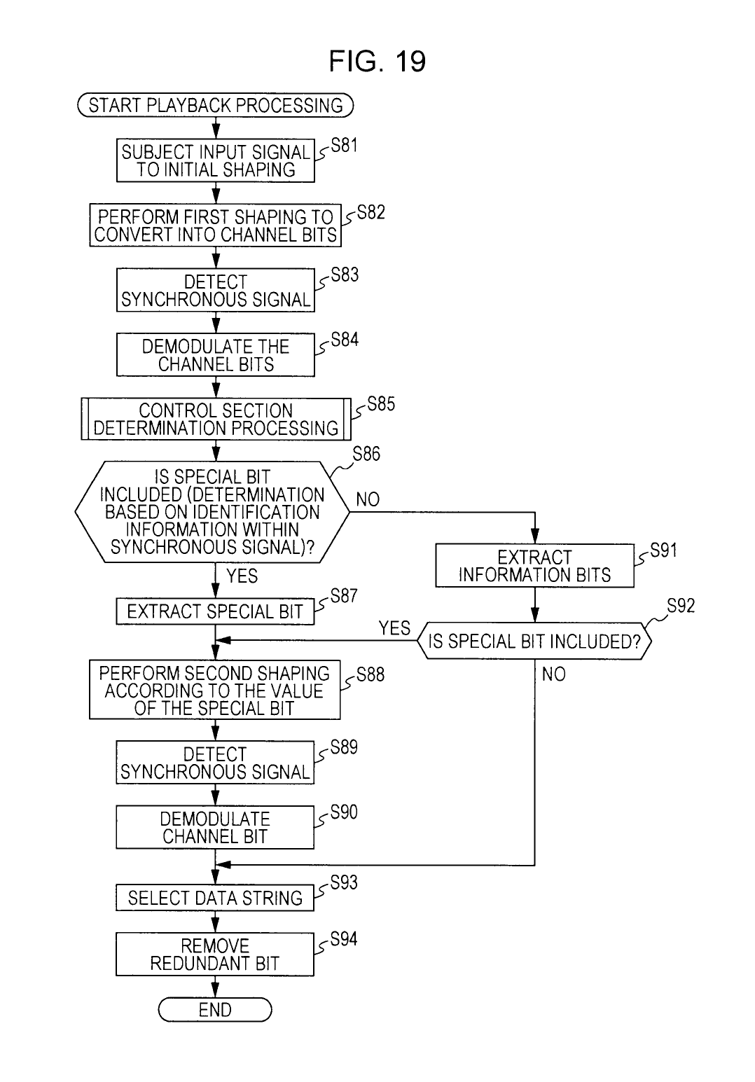

As described later, in the event that a configuration for performing DSV control (DSV control processing unit 61 in FIG. 19) is provided to the switching processing unit 17, the information of the DSV control section W determined by the control section determining unit 15 is supplied to the switching processing unit 17, and used for DSV control of a DSV control section which is an object.

With the switching processing unit 17, signal processing is performed according to the value of a special bit, and a data string with information bits X22 is generated by demodulating the channel bit string obtained by the signal processing. Redundant bits such as a synchronous signal, a DSV bit D, a special bit S, and so forth are removed from the data string with information bits X22 by the removing unit 18, and a data string X21 is generated.

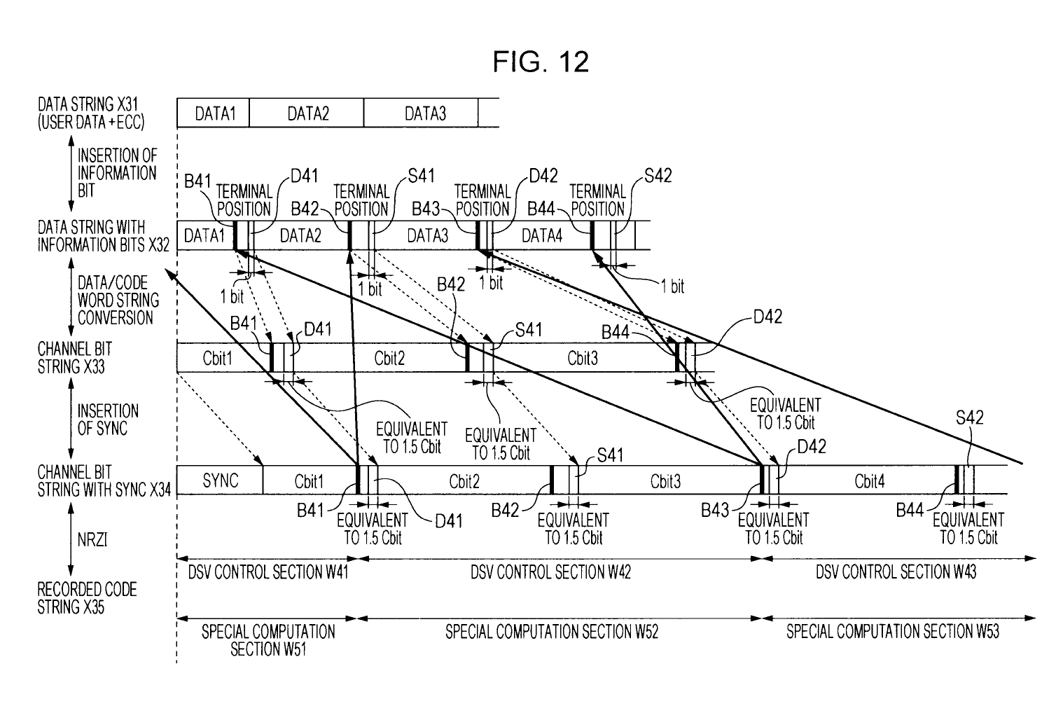

FIG. 12 is a diagram illustrating another example of control sections made up of DSV control sections and special computation sections. With the example in FIG. 12 as well, as with the case in FIG. 11, a part of information bits are replaced with special bits, and the rest thereof is kept as a DSV bit.

For example, continuous control delimiters B are selected every other piece, and a section between the selected control delimiters B is taken as a DSV control section, and also the same section is taken as a special computation section.

With the example in FIG. 12, as shown on the fourth stage, a section between a control delimiter B41 and a control delimiter B43 skipping a control delimiter B42 is taken as a DSV control section W42 and also as a special computation section W52. Similarly, a section between the control delimiter B43 and a control delimiter B45 (not shown) skipping a control delimiter B44 is taken as a DSV control section W43 and also as a special computation section W53.

A DSV bit is disposed within a DSV control section serving as a computation object. For example, a DSV obtained as a result of DSV computation with the DSV control section W42 as an object is disposed within the DSV control section W42 as a DSV bit D41. Similarly, a DSV obtained as a result of DSV computation with the DSV control section W43 as an object is disposed within the DSV control section W43 as a DSV bit D42.

On the other hand, a special bit is disposed outside a special computation section which is an object. For example, the special bit with the special computation section W51 as an object is taken as a special bit S41, and is disposed outside the special computation section W51, within the special computation section W52 thereafter. Similarly, the special bit with the special computation section W52 as an object is taken as a special bit S42, and is disposed outside the special computation section W52, within the special computation section W53 thereafter.

With the example in FIG. 12, a DSV control section and a special computation section are set so as to be overlapped. Also, with the example in FIG. 12, the insertion position of a special bit is disposed backward as to the special computation section which is an object as compared to the case in FIG. 11.

According to the method in FIG. 12, the DSV control section W and the special computation section W are set with the same control delimiter B as a reference, whereby simplification of the hardware configuration can be realized.

Note that, with the example in FIG. 12, the control delimiter B in the vicinity of the DSV bit D is taken as a delimiter of control sections, but control sections may also be set with a control delimiter B in the vicinity of a special bit S as a delimiter.

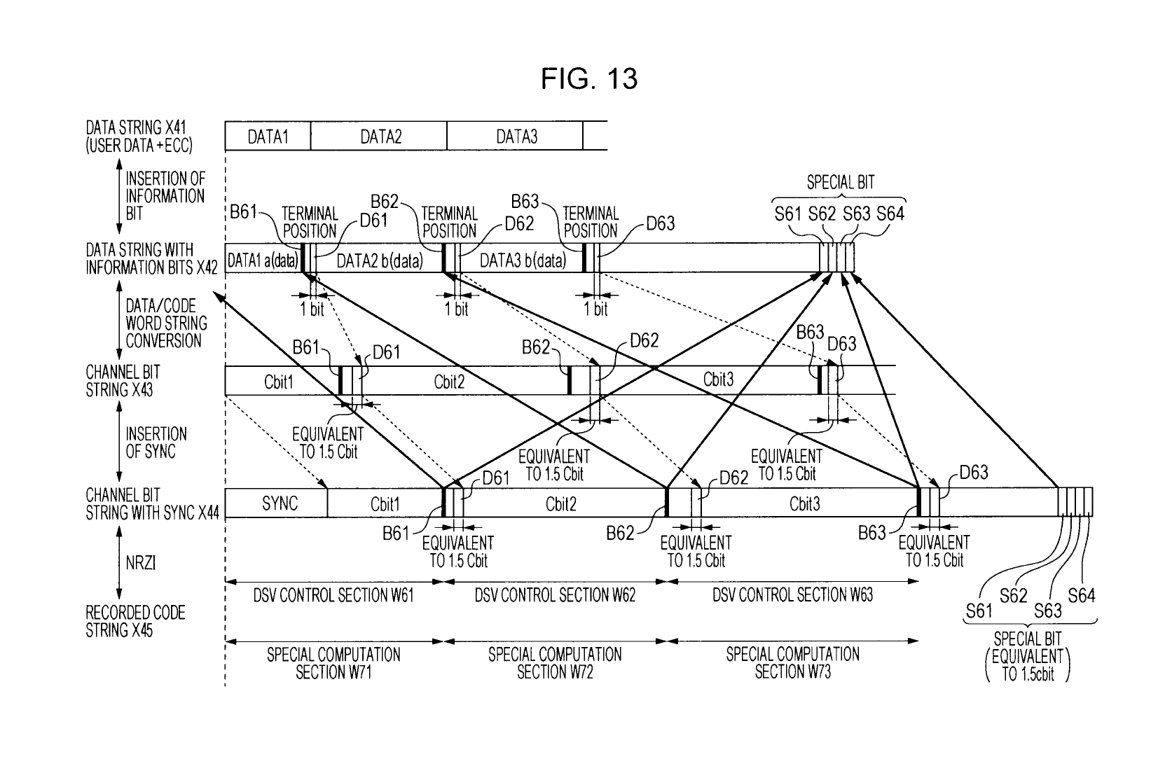

FIG. 13 is a diagram illustrating another example of control sections made up of DSV control sections and special computation sections. With the example in FIG. 13 as well, in the same way as with the case in FIG. 12, a section between a certain control delimiter B and the next control delimiter B is taken as a DSV control section, and also the same section is taken as a special computation section.

With the example in FIG. 13, a section between a control delimiter B61 and the next control delimiter B62 is taken as a DSV control section W62 and also as a special computation section W72. Similarly, a section between the control delimiter B62 and the next control delimiter B63 is taken as the next DSV control section W63 and also as a special computation section W73.

A DSV bit is disposed within a DSV control section serving as a computation object. For example, a DSV obtained as a result of DSV computation with the DSV control section W62 as an object is disposed within the DSV control section W62 as a DSV bit D61. Similarly, a DSV obtained as a result of DSV computation with the DSV control section W63 as an object is disposed within the DSV control section W63 as a DSV bit D62.

On the other hand, special bits are collectively disposed outside a special computation section which is an object. For example, special bits S61, S62, and S63 that take the special computation sections W71, W72, and W73 as objects respectively are collectively disposed at the end of the data string. In this way, multiple special bits may collectively be disposed.

The signal of a channel bit string obtained by modulating the data string into which a special bit is inserted as appropriate as described above is input to the data demodulating device 1.

Description has been made so far wherein a special bit is inserted into the data string, but in the event that the 6-bit additional information is included in the synchronous signal, a special bit may be described using all or a part of the 6 bits that are additional information.

In this case, extraction of a special bit is performed by the synchronous signal detecting unit 13, for example. The information of the special bit extracted from the channel bit string output from the shaping unit 12 is supplied from the synchronous signal detecting unit 13 to the special information processing unit 16, and used for control of signal processing at the switching processing unit 17.

A special bit is included in a synchronous signal block, whereby processing of the data string following the synchronous signal can rapidly be switched according to the value of a special bit included in the synchronous signal block.

The content of signal processing may be specified by combining multiple special bits. For example, two special bits are used, whereby the data modulating device 1001 can specify four types of signal processing as to the data demodulating device 1.

Description has been made so far wherein one special bit is inserted with each of the special computation sections as an object, a special bit that takes the entire FS section as an object may be inserted. Also, a special bit that takes the entire data in increments of blocks as an object described with reference to FIG. 4 may be inserted.

Timing for switching processing in the event of a special bit having been obtained is arbitrary. For example, in the event that a special bit that takes a special computation section as an object has been obtained, processing may be switched immediately after the special bit is obtained, or processing may be switched at timing when the channel bit string of the next special computation section of the special computation section in which the special bit is inserted becomes a processing object.

Also, in the event that a special bit that takes the FS section as an object has been obtained, processing may be switched from the FS section serving an a processing object immediately after the special bit is obtained, or processing may be switched at timing when the channel bit string of the next FS section of the FS section in which the special bit is inserted becomes a processing object.

### Third Embodiment

### Configuration of Data Modulating Device

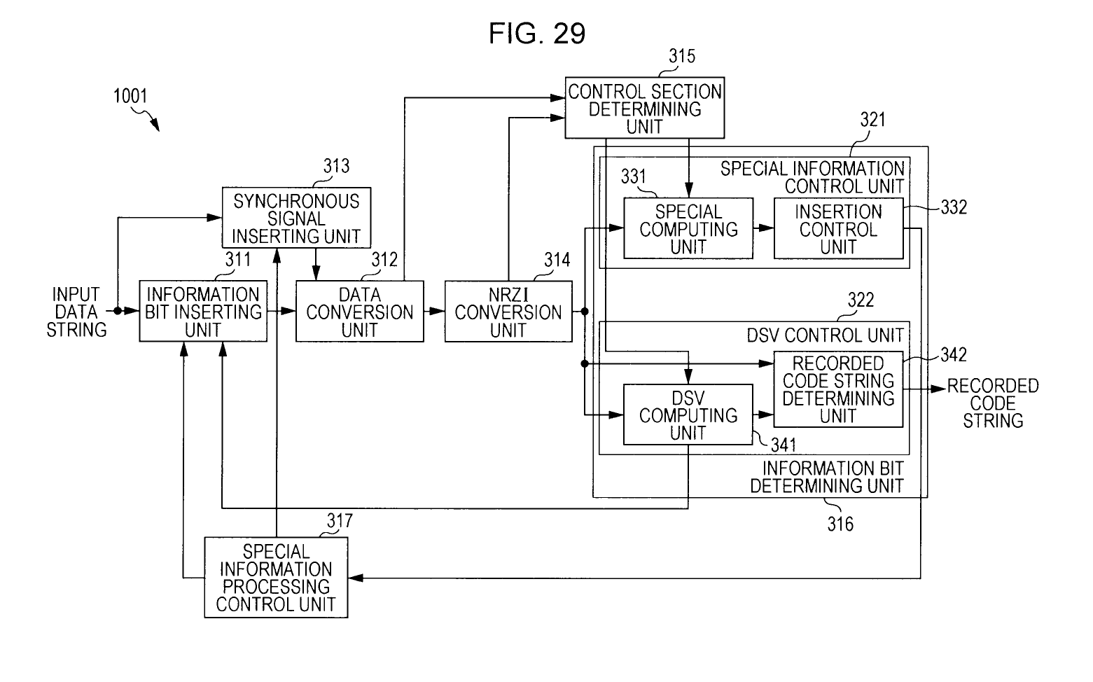

FIG. 29 is a block diagram illustrating another configuration example of the data modulating device. The data modulating device 1001 in FIG. 29 differs from the data modulating device 1001 in FIG. 25 in that information representing whether or not insertion of a special bit has been performed is arranged to be supplied from the special information processing control unit 317 to the synchronous signal inserting unit 313.

The synchronous signal inserting unit 313 in FIG. 29 generates a synchronous signal including additional information based on the information supplied from the special information processing control unit 317, and outputs to the data conversion unit 312.

For example, 30 channel bits are provided as the synchronous signal generated by the synchronous signal inserting unit 313. The pattern of 24 channel bits of the 30 channel bits is the same as with the pattern of the 24 channel bits generated by the synchronous signal inserting unit 313 in FIG. 25 as follows.
#01 001 000 000 001 000 000 001 (24 channel bits)
#=0 not terminate case
#=1 terminate case

6 channel bits other than the 24 channel bits having the above pattern are included in the synchronous signal of the 30 channel bits that the synchronous signal inserting unit 313 in FIG. 29 generates, as additional information. This additional information may be used for having multiple types of synchronous signals for the system, or may be used for identification of another object. These added 6 channel bits are used to describe whether or not all or a part of DSV bits are replaced with a special bit, i.e., whether or not a special bit is included in the data string.

Also, the 6 channel bits are used to describe a special bit itself as appropriate. In this way, a special bit may be disposed within a synchronous signal. A special bit is inserted into a synchronous signal, whereby processing of the channel bits following the synchronous signal can be switched according to the value of a special bit included in a synchronous signal.

According to such 6-bit additional information, for example, the following structure made up of DSV bits and special bits arrayed in a complicated sequence can be realized.

DSV bit—special bit—special bit—DSV bit—special bit—special bit—DSV bit—and so on

In this case, a rule is determined on the encoder (data modulating device) side and the decoder (data demodulating device) side regarding alignment of DSV bits and special bits.

Further, a particular pattern may be described as additional information regarding a technique for control delimiter. For example, as described above, with the position of an information bit inserted into the data as a reference, description may be included wherein a control delimiter B is set to a position immediately after a bit prior to a certain number of bits from the information bit. In this case, information based on the channel bits following the fixed delimiter can be taken as additional information. Thus, recording/playback processing can be performed in a surer manner.

In this way, information different from normal can be added while keeping the rule of the modulation table in FIG. 2. The other configurations and operations in FIG. 29 are the same as with the corresponding configuration in FIG. 25. Redundant description will be omitted.

### Fourth Embodiment

### Configuration of Data Modulating Device

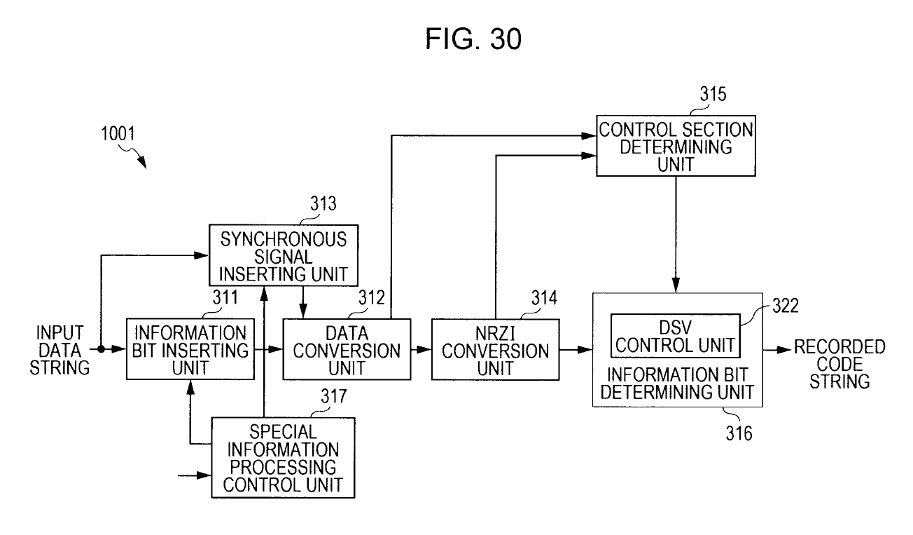

FIG. 30 is a block diagram illustrating yet another configuration example of the data modulating device according to an embodiment of the present disclosure. With the example in FIG. 30, control information for instructing the insertion position of an information bit is externally input to the special information processing control unit 317. The control information is input according to operations by the user, for example. Also, with the example in FIG. 30, the information bit determining unit 316 is configured of the DSV control unit 322 alone. The other configurations are the same configurations as the configurations described with reference to FIG. 24.

The information bit inserting unit 311 inserts an information bit into the input data string with a predetermined interval in accordance with the control by the special information processing control unit 317. The information bit that the information bit inserting unit 311 inserts is a special bit or DSV bit.

For example, the information bit inserting unit 311 inserts a DSV bit into the odd number'th control sections, and inserts a special bit into the even number'th control sections for each FS section, with the head control section as the first control section. It is specified by the control information to insert a DSV bit into which control section, and to insert a special bit into which control section.

The information bit inserting unit 311 outputs the data string into which an information bit is inserted to the data conversion unit 312.

The data conversion unit 312 converts the data supplied from the information bit inserting unit 311 into a channel bit string. Also, the data conversion unit 312 synthesizes the channel bit string supplied from the information bit inserting unit 311, and the synchronous signal supplied from the synchronous signal inserting unit 313, and outputs to the NRZI conversion unit 314.

The synchronous signal inserting unit 313 generates a synchronous signal in sync with the input data string, and outputs to the data conversion unit 312. Additional information representing whether or not a special bit is inserted may be included in the synchronous signal.

The NRZI conversion unit 314 subjects the channel bit string supplied from the data conversion unit 312 to NRZI conversion, and outputs the level code obtained by NRZI conversion to the control section determining unit 315, and the DSV control unit 322 of the information bit determining unit 316.

The control section determining unit 315 sets a DSV control section based on information relating to the level code supplied from the NRZI conversion unit 314, and information relating to variable length at the time of converting the data into channel bits, supplied from the data conversion unit 312. The control section determining unit 315 outputs the information of the set DSV control section to the information bit determining unit 316.

The DSV control unit 322 performs DSV computation based on the channel bits of the DSV control section set by the control section determining unit 315. The DSV control unit 322 generates a level code including a value 0, and a level code including a value 1, as a DSV bit based on the level code input from the NRZI conversion unit 314, and selects one thereof, and outputs as a recorded code string.

### Modification

Description has been made so far wherein the content of EQ processing, PRML processing, and filtering processing is specified by the value of a special bit, but the content of other processing may be specified by a special bit.

### Fifth Embodiment

### Configuration of Data Demodulating Device

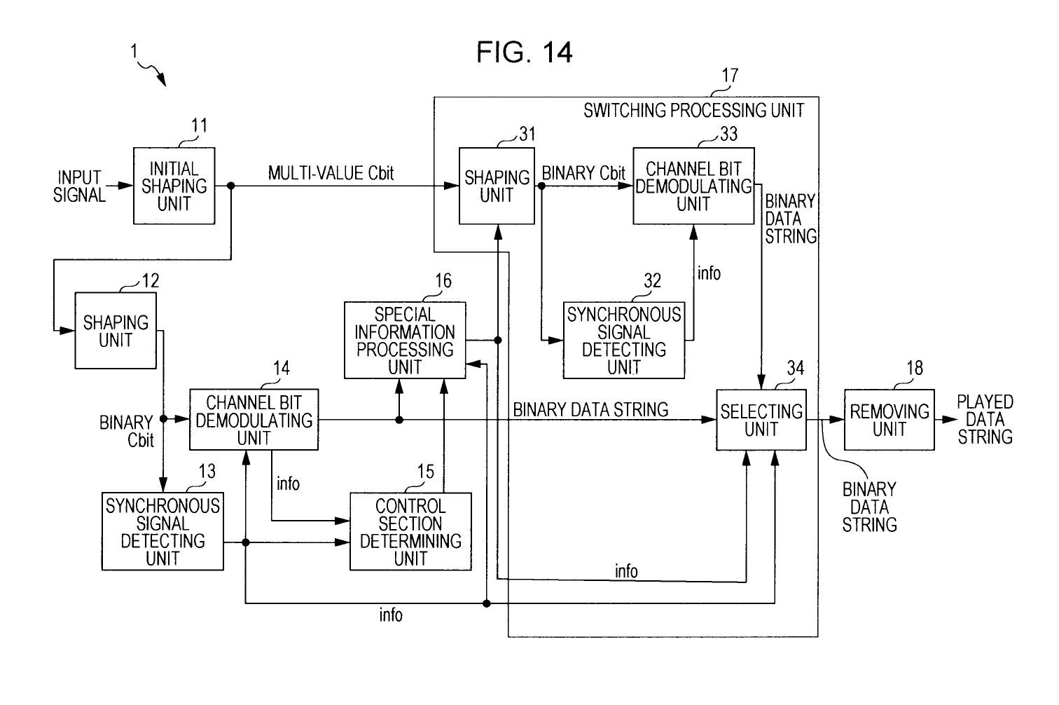

FIG. 14 is a block diagram illustrating a specific example of the configuration of the data demodulating device 1. With the data demodulating device 1 in FIG. 14, the switching processing unit 17 is configured of a shaping unit 31, a synchronous signal detecting unit 32, a channel bit demodulating unit 33, and a selecting unit 34. The other configurations shown in FIG. 14 are the same as the configurations in FIG. 3. Redundant description will be omitted as appropriate.

The multi-value channel bit string output from the initial shaping unit 11 is supplied to the shaping unit 31, and information representing the timing of the synchronous signal detected by the synchronous signal detecting unit 13, and identification information representing whether or not a special bit is included in the data string are supplied to the selecting unit 34. Also, the value of the special bit obtained by the special information processing unit 16, and information representing a section that the special bit takes as an object are supplied to the shaping unit 31 and the selecting unit 34.

The shaping unit 31 of the switching processing unit 17 performs second shaping processing according to the value of a special bit as to the channel bit string supplied from the initial shaping unit 11.

Specifically, in the event that the value of the special bit is 0, the shaping unit 31 performs, for example, predetermined EQ processing and PRML processing (PR121) that are the normal processing, and when further performing filtering processing using an FIR filter, performs filtering processing using an FIR filter having normal properties.

On the other hand, in the event that the value of the special bit is 1, the shaping unit 31 performs, for example, predetermined EQ processing and PRML processing (PR1221) that are the special processing, and when further performing filtering processing using an FIR filter, performs filtering processing using an FIR filter having a property for further enhancing high-frequency components.

The shaping unit 31 converts the signal subjected to the second shaping processing into a channel bit string made up of binaries of 0 or 1 in the same way as with the shaping unit 12, and outputs to the synchronous signal detecting unit 32 and the channel bit demodulating unit 33.

The synchronous signal detecting unit 32 detects a synchronous signal inserted into the channel bit string supplied from the shaping unit 31 with a predetermined interval in the same way as with the synchronous signal detecting unit 13. The synchronous signal detecting unit 32 outputs information representing the detected timing of the synchronous signal to the channel bit demodulating unit 33.

The channel bit demodulating unit 33 demodulates the channel bit string supplied from the shaping unit 31 in accordance with the demodulation table in FIG. 2 having a variable-length structure to output a binary data string. At this time, the channel bit string from the shaping unit 31 is converted into an edge code by subjecting the level code to inverse NRZI conversion as appropriate. The channel bit demodulating unit 33 outputs the data string obtained by demodulation to the selecting unit 34.

The selecting unit 34 selects one of the data string supplied from the channel bit demodulating unit 14, and the data string supplied from the channel bit demodulating unit 33 based on the identification information supplied from the synchronous signal detecting unit 13.

For example, in the event that the identification information represents that a special bit is inserted, the selecting unit 34 selects the data string supplied from the channel bit demodulating unit 33. Also, in the event that the identification information represents that no special bit is inserted, the selecting unit 34 selects the data string supplied from the channel bit demodulating unit 14. The selecting unit 34 outputs the selected data string to the removing unit 18.

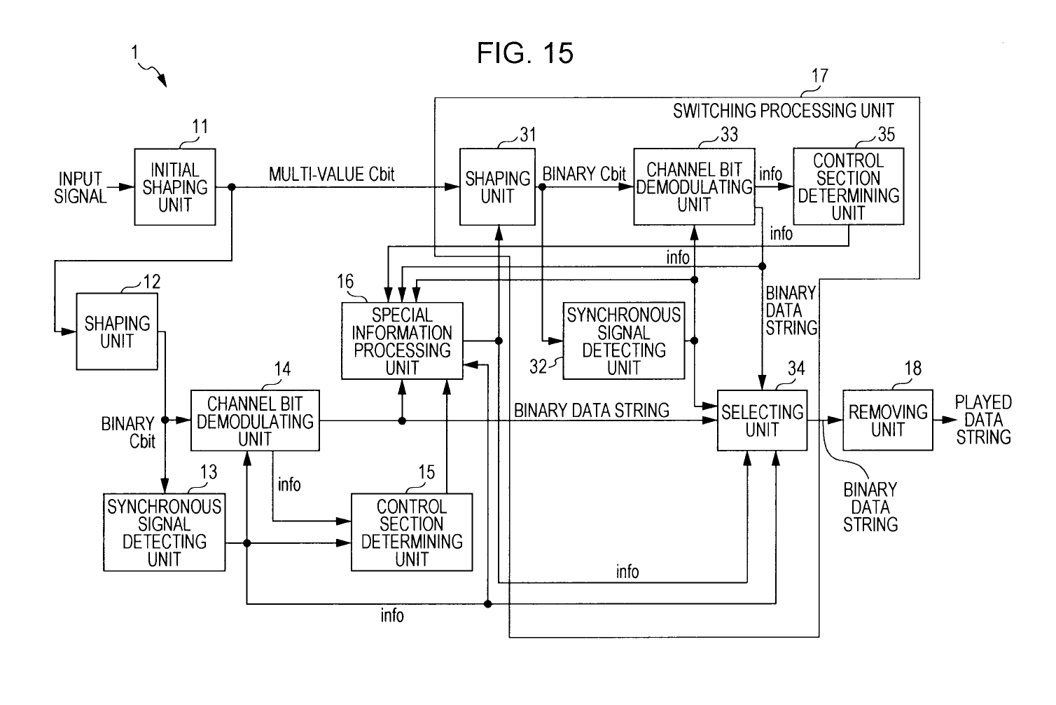

FIG. 15 is a diagram illustrating a modification of the configuration of the data demodulating device 1 in FIG. 14. The configuration of the data demodulating device 1 illustrated in FIG. 15 differs from the configuration in FIG. 14 in that a control section determining unit 35 is additionally provided to the switching processing unit 17. The data demodulating device 1 in FIG. 15 is configured so as to determine whether or not there is a special bit based on the signal subjected to the second shaping processing. Redundant description will be omitted as appropriate.

The shaping unit 31 converts the signal obtained by performing the second shaping processing into a binary channel bit string, and outputs to the synchronous signal detecting unit 32 and the channel bit demodulating unit 33.

The synchronous signal detecting unit 32 detects a synchronous signal inserted into the channel bit string supplied from the shaping unit 31, and also detects identification information included in the synchronous signal. The synchronous signal detecting unit 32 supplies information representing the detected timing of the synchronous signal, and the identification information to the special information processing unit 16, channel bit demodulating unit 33, and selecting unit 34.

The channel bit demodulating unit 33 demodulates the channel bit string supplied from the shaping unit 31 to output a binary data string. The data string output from the channel bit demodulating unit 33 is supplied to the selecting unit 34, and also supplied to the special information processing unit 16. Also, the channel bit demodulating unit 33 outputs information relating to the position of each data making up the data string to the control section determining unit 35.

In the event that a special bit is inserted, the selecting unit 34 selects the data string supplied from the channel bit demodulating unit 33, and in the event that no special bit is inserted, selects the data string supplied from the channel bit demodulating unit 14.

The control section determining unit 35 detects a delimiter for data conversion based on the information supplied from the channel bit demodulating unit 33, and determines a control section based on the detected delimiter. With the control section determining unit 35, a control section is determined by the same processing as the processing by the control section determining unit 15 being performed. The control section determining unit 35 outputs the information of a special computation section to the special information processing unit 16.

In the event that the identification information supplied from the synchronous signal detecting unit 32 represents that the data string includes a special bit, the special information processing unit 16 extracts the special bit from the data string supplied from the channel bit demodulating unit 33. A special computation section serving as a reference for extraction of a special bit is specified by the control section determining unit 35. The special information processing unit 16 outputs the value of a special bit, and information representing a section that the special bit takes as an object to the shaping unit 31, and controls signal processing by the shaping unit 31.

In this way, with the data demodulating device 1 in FIG. 15, based on the data string obtained by demodulating the channel bit string subjected to the second shaping processing, determination is made whether or not a special bit is included in the data string. Also, in the event that determination is made that a special bit is included, the special bit is extracted from the data string obtained by demodulating the channel bit string subjected to the second shaping processing, and signal processing at the switching processing unit 17 is switched.

Note that, with regard to a process wherein a special bit is extracted from the data string obtained by demodulating the channel bit string subjected to the first shaping processing, and signal processing at the switching processing unit 17 is switched, and a process wherein a special bit is extracted from the data string obtained by demodulating the channel bit string subjected to the second shaping processing, and signal processing at the switching processing unit 17 is switched, both of the processes thereof may be performed, or one of the processes thereof may be performed.

### Operation of Data Demodulating Device

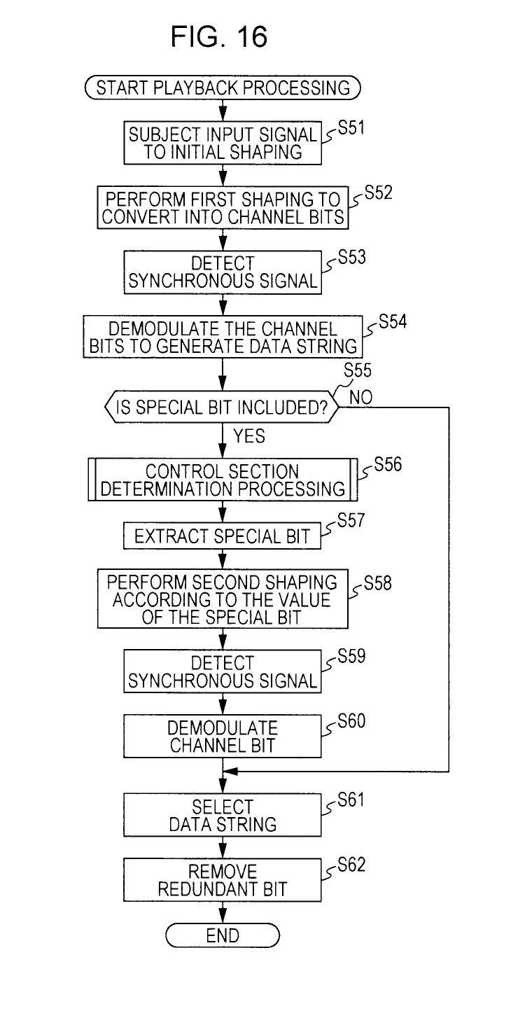

The playback processing of the data demodulating device 1 in FIG. 14 will be described with reference to the flowchart in FIG. 16. The processing in FIG. 16 is basically the same processing as the processing described with reference to FIG. 5. Redundant description will be omitted as appropriate.

In step S51, the initial shaping unit 11 performs initial shaping of an input signal.

In step S52, the shaping unit 12 performs the first shaping processing as to the input signal subjected to the initial shaping, and further subjects to binary conversion, thereby generating a channel bit string.

In step S53, the synchronous signal detecting unit 13 detects a synchronous signal from the channel bit string generated by the shaping unit 12. Also, the synchronous signal detecting unit 13 detects identification information included in the synchronous signal.

In step S54, the channel bit demodulating unit 14 demodulates the channel bit string generated by the shaping unit 12 to output a binary data string.

In step S55, the synchronous signal detecting unit 13 determines whether or not a special bit is included in the data string, based on the detected identification information.

In the event that determination is made in step S55 that a special bit is included, in step S56 the control section determining unit 15 executes control section determination processing. The control section determination processing performed here is the same processing as the processing described with reference to the flowchart in FIG. 6.

In step S57, the special information processing unit 16 extracts the special bit from the data string supplied from the channel bit demodulating unit 14.

In step S58, the shaping unit 31 performs the second shaping processing according to the value of the special bit as to the channel bit string supplied from the initial shaping unit 11 to generate a binary channel bit string from the multi-value channel bit string subjected to the second shaping processing.

In step S59, the synchronous signal detecting unit 32 detects a synchronous signal inserted into the channel bit string generated by the shaping unit 31.

In step S60, the channel bit demodulating unit 33 demodulates the channel bit string generated by the shaping unit 31 to output a binary data string.

In the event that determination is made in step S55 that no special bit is included, the processing in steps S56 through S60 is skipped.

In step S61, the selecting unit 34 selects a data string. Specifically, in the event that a special bit is included in the channel data bit string, the selecting unit 34 selects the data string supplied from the channel bit demodulating unit 33. On the other hand, in the event that the processing in steps S56 through S60 has been skipped since no special bit is included in the channel data bit string, the selecting unit 34 selects the data string supplied from the channel bit demodulating unit 14.

In step S62, the removing unit 18 removes redundant bits from the data string selected by the switching processing unit 17, and outputs the data string from which the redundant bits are removed, as a playback data string. Thereafter, the processing is ended.

In this way, the system for playing a recoding medium in which a part of DSV bits inserted with a predetermined interval are recorded by being replaced with a special bit can determine that a special bit is embedded instead of a DSV bit, from the identification information.

Also, the content of signal processing can be switched so as to perform more suitable processing according to the recorded position of the channel bit string, or occurrence frequency of 2T by taking advantage of a special bit inserted instead of a DSV bit. That is to say, playback properties can further be stabilized.

### Third Embodiment

### Configuration of Data Demodulating Device

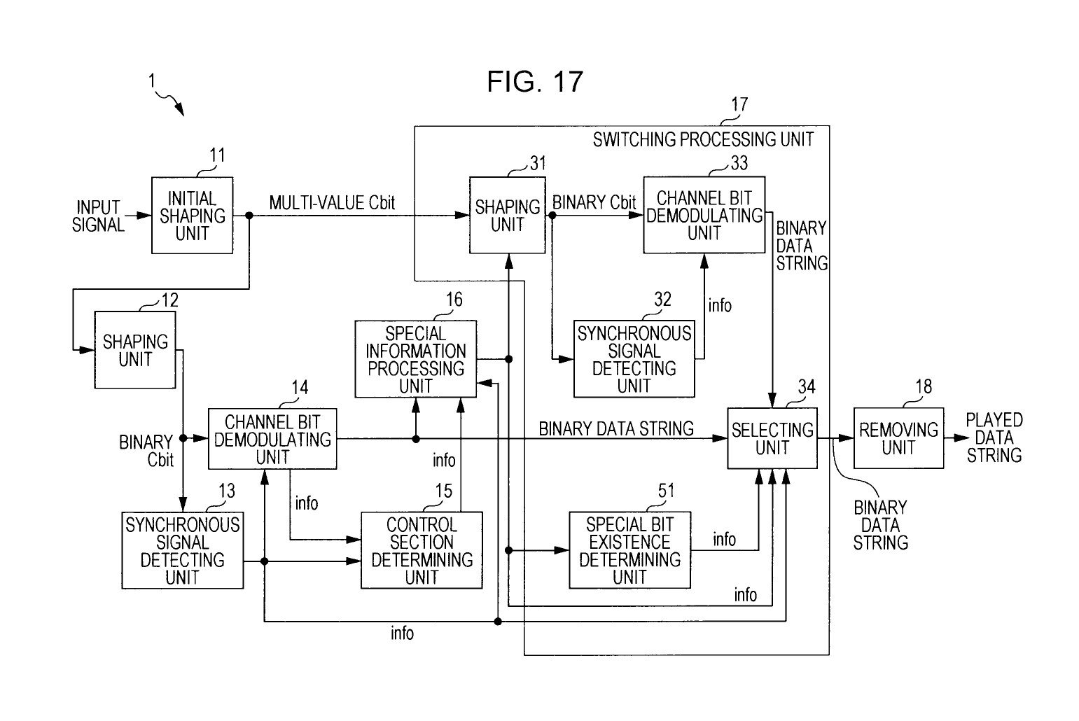

FIG. 17 is a block diagram illustrating another specific example of the configuration of the data demodulating device 1. With the data demodulating device 1 in FIG. 17, the switching processing unit 17 is configured of a special bit existence determining unit 51 in addition to the shaping unit 31, synchronous signal detecting unit 32, channel bit demodulating unit 33, and selecting unit 34. The configurations other than the special bit existence determining unit 51 are basically the same configurations as the configurations in FIG. 14. Redundant processing will be omitted as appropriate.

The special bit existence determining unit 51 accumulates information output from the special information processing unit 16, and determines whether or not there is a special bit. Thus, even in the event that identification information is not included in the synchronous signal as additional information, determination can be made whether or not a special bit is included in the data string.

Description will be made regarding determination of whether or not there is a special bit by the special bit existence determining unit 51.

With this example, an information bit of which the insertion position is determined with the control section determined by the control section determining unit 15 as a reference is extracted from the data string by the special information processing unit 16 regardless of the information bit thereof being a DSV bit or special bit. The information of the value of the information bit (the value of the DSV bit in the event that a DSV bit is inserted, or the value of the special bit in the event that a special bit is inserted instead of a DSV bit) extracted by the special information processing unit 16 is supplied to the special bit existence determining unit 51.

The special bit existence determining unit 51 accumulates the information supplied from the special information processing unit 16 by predetermined number, and determines, based on the change pattern of the value of the information bit, whether or not a special bit is included in the data string.

In the event that the information bit is a DSV bit, it can be conceived that the values of the information bits change to 1 or 0 with a certain degree of a random manner. On the other hand, in the event that the information bit is a special bit, it can be conceived that, as described above, when the information bit is inserted depending on whether the recorded position of data is a position on the inner circumferential side or outer circumferential side of the optical disc, the values of the information bits continue with the same value to some extent.

In the event that the same values continue in more than a predetermined number as the values of information bits, the special bit existence determining unit 51 determines that a special bit is inserted, and in the event that the same values do not continue in more than a predetermined number, determines that no special bit is inserted.

An arrangement may be made wherein a percentage wherein the value of an information bit is 1, and a percentage wherein the value of an information bit is 0 are computed, and in the event that one of the percentages is equal to or higher than a threshold as compared to the other percentage, determination is made that a special bit is inserted, and in the event of lower than the threshold, determination is made that no special bit is inserted.

The special bit existence determining unit 51 outputs information representing the determination result of whether or not there is a special bit to the selecting unit 34.

In the event that determination is made by the special bit existence determining unit 51 that a special bit is inserted, the selecting unit 34 selects the data string supplied from the channel bit demodulating unit 33. Also, in the event that determination is made by the special bit existence determining unit 51 that no special bit is inserted, the selecting unit 34 selects the data string supplied from the channel bit demodulating unit 14. The selecting unit 34 outputs the selected data string to the removing unit 18.

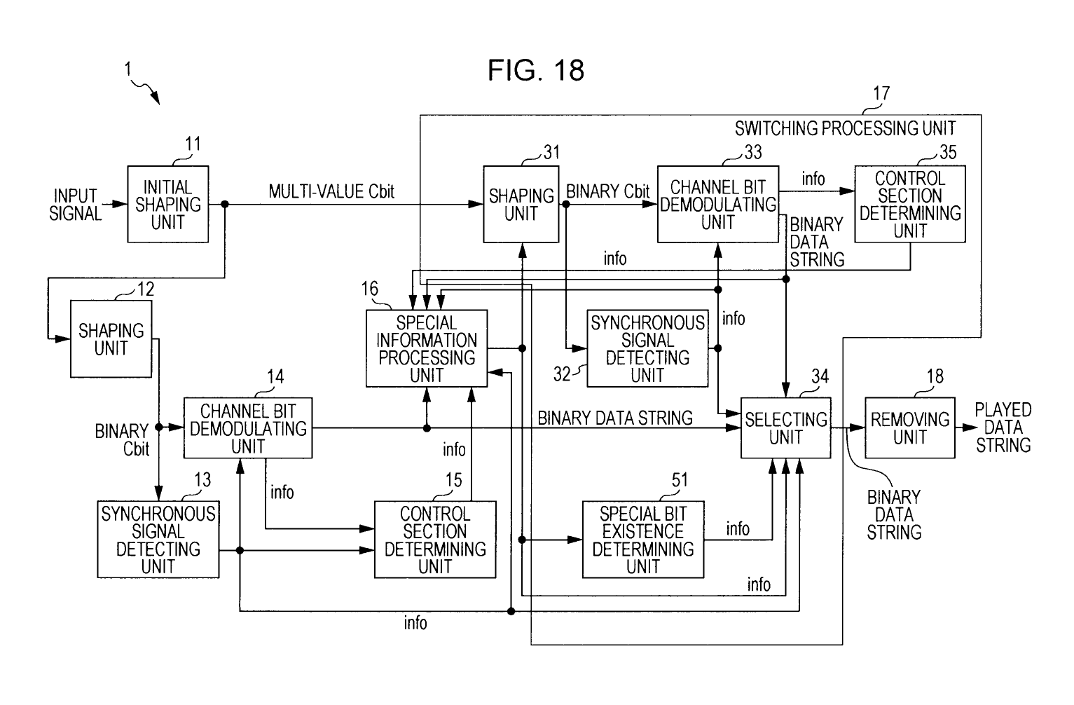

FIG. 18 is a diagram illustrating a modification of the configuration of the data demodulating device 1 in FIG. 17. The configuration of the data demodulating device 1 illustrated in FIG. 18 differs from the configuration in FIG. 17 in that a control section determining unit 35 is additionally provided to the switching processing unit 17. With the data demodulating device 1 in FIG. 18 as well, as described with reference to FIG. 15, as appropriate, determination is made based on the signal subjected to the second shaping processing whether or not there is a special bit.

### Operation of Data Demodulating Device

The playback processing of the data demodulating device 1 in FIG. 17 will be described with reference to the flowchart in FIG. 19.

In step S81, the initial shaping unit 11 performs initial shaping of an input signal.

In step S82, the shaping unit 12 performs the first shaping processing as to the input signal subjected to the initial shaping, and further performs binary conversion, thereby generating a channel bit string.

In step S83, the synchronous signal detecting unit 13 detects a synchronous signal from the channel bit string generated by the shaping unit 12. Also, in the event that identification information is included in the synchronous signal, the synchronous signal detecting unit 13 detects the identification information.

In step S84, the channel bit demodulating unit 14 demodulates the channel bit string generated by the shaping unit 12 to output a binary data string.

In step S85, the control section determining unit 15 executes control section determination processing. The control section determination processing performed here is the same processing as the processing described with reference to the flowchart in FIG. 6.

In step S86, the synchronous signal detecting unit 13 determines based on the identification information whether or not a special bit is included. Here, the identification information is included in the synchronous signal, and in the event that the identification information included in the synchronous signal represents that a special bit is included, determination is made that a special bit is included. On the other hand, the identification information is included in the synchronous signal, and in the event that the identification information included in the synchronous signal represents that no special bit is included, or in the event that no identification information is included in the synchronous signal, determination is made that no special bit is included.

In the event that determination is made in step S86 that a special bit is included, in step S87 the special information processing unit 16 extracts the special bit from the data string supplied from the channel bit demodulating unit 14.

In step S88, the shaping unit 31 performs the second shaping processing according to the value of the special bit as to the channel bit string supplied from the initial shaping unit 11 to generate a binary channel bit string from the multi-value channel bit string subjected to the second shaping processing.

In step S89, the synchronous signal detecting unit 32 detects a synchronous signal inserted into the channel bit string generated by the shaping unit 31.

In step S90, the channel bit demodulating unit 33 demodulates the channel bit string generated by the shaping unit 31 to output a binary data string.

On the other hand, in the event that determination is made in step S86 that no special bit is included, in step S91 the special information processing unit 16 extracts an information bit from the data string supplied from the channel bit demodulating unit 14. The information bit extracted by the special information processing unit 16 may be a DSV bit or a special bit. Information representing the value of the information bit extracted by the special information processing unit 16 is supplied to the special bit existence determining unit 51, and accumulated.

In step S92, the special bit existence determining unit 51 determines the change pattern of the value of the information bit based on the accumulated information, and determines whether or not a special bit is included in the data string.

In the event that determination is made in step S92 that a special bit is included in the data string, processing in step S88 and thereafter is performed. On the other hand, in the event that determination is made in step S92 that no special bit is included in the data string, the processing in steps S88 through S90 is skipped.

In step S93, the selecting unit 34 selects a data string. Specifically, in the event that a special bit is included in the data string, the selecting unit 34 selects the data string supplied from the channel bit demodulating unit 33. On the other hand, in the event that no special bit is included in the data string, the selecting unit 34 selects the data string supplied from the channel bit demodulating unit 14.

In step S94, the removing unit 18 removes redundant bits from the data string selected by the switching processing unit 17, and outputs the data string from which the redundant bits are removed, as a playback data string. Thereafter, the processing is ended.

According to the above processing, a case goes without saying wherein identification information is included as the additional information of a synchronous signal, and even in the event that no identification information is included, playback properties can further be stabilized.

### Fourth Embodiment

### Configuration of Data Demodulating Device

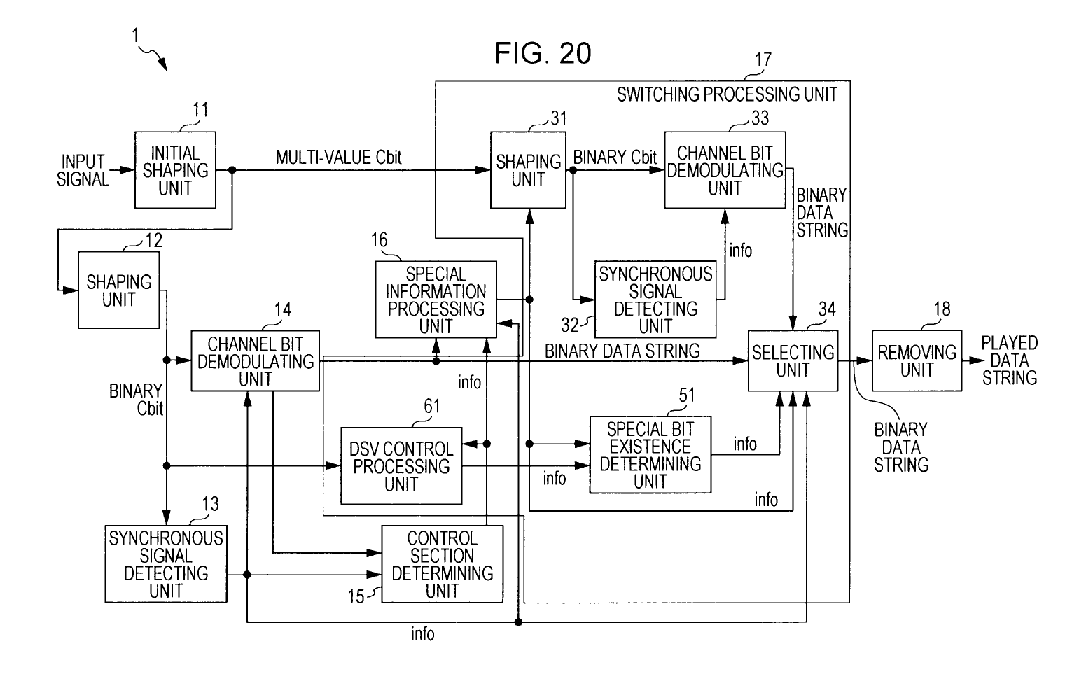

FIG. 20 is a block diagram illustrating a configuration example of the data demodulating device 1. With the data demodulating device 1 in FIG. 20, the switching processing unit 17 is configured of a DSV control processing unit 61 in addition to the shaping unit 31, synchronous signal detecting unit 32, channel bit demodulating unit 33, selecting unit 34, and special bit existence determining unit 51. Description redundant with the description in FIG. 17 will be omitted as appropriate.

The synchronous signal detecting unit 13 in FIG. 20 detects a synchronous signal from the channel bit string that the shaping unit 12 outputs, and outputs information representing timing thereof to each unit. The synchronous signal detecting unit 13 differs from the synchronous signal detecting unit 13 in FIG. 17 and others in that a function for detecting identification information included in a synchronous signal is not provided.

The DSV control processing unit 61 computes a DSV with each of the DSV control sections as an object based on the channel bit string supplied from the shaping unit 12. Specifically, the DSV control processing unit 61 performs integration with “1” included in the channel bit string as +1, and “0” as −1. The DSV control processing unit 61 outputs the information of the calculated DSVs to the special bit existence determining unit 51.

The special bit existence determining unit 51 accumulates the information from the DSV control processing unit 61, and the information from the special information processing unit 16, and determines whether or not there is a special bit. Information representing the value of an information bit is supplied from the special information processing unit 16 in the same way as with the case described with reference to FIG. 17.

Here, all of the bits inserted as information bits are DSV bits, and in the event that there is no special bit, the absolute value of a DSV obtained by the DSV control processing unit 61 approximates to 0. Accordingly, in the event that the absolute value of a DSV is smaller than a first reference value, determination can be made that there is no special bit.

On the other hand, as a replacement rate from a DSV bit to a special bit increases, the DSV bit decreases, and accordingly, the absolute value of the DSV increases. Accordingly, in the event that the absolute value of a DSV is greater than a second reference value, determination can be made that there is a special bit.

Also, in the event that there are not only a format where the insertion interval of an information bit is every 45 bits, but also a format for every 91 bits, when the replacement rates from a DSV bit to a special bit are the same, the absolute value of a DSV of the former is smaller.

Therefore, the special bit existence determining unit 51 determines whether or not a special bit is included in the data string by comparing the absolute value of a DSV obtained by the DSV control processing unit 61 with the first or second reference value.

Also, the special bit existence determining unit 51 determines, in the same way as with the case described with reference to FIG. 17, whether or not a special bit is included in the data string by also combining determination based on the change pattern of the value of an information bit as appropriate. For example, an arrangement may be made wherein in the event that the change pattern of the value of an information bit indicates a pattern including a special bit, and also the absolute value of a DSV obtained by the DSV control processing unit 61 is greater than the second reference value, determination is made that a special bit is included in the data string.

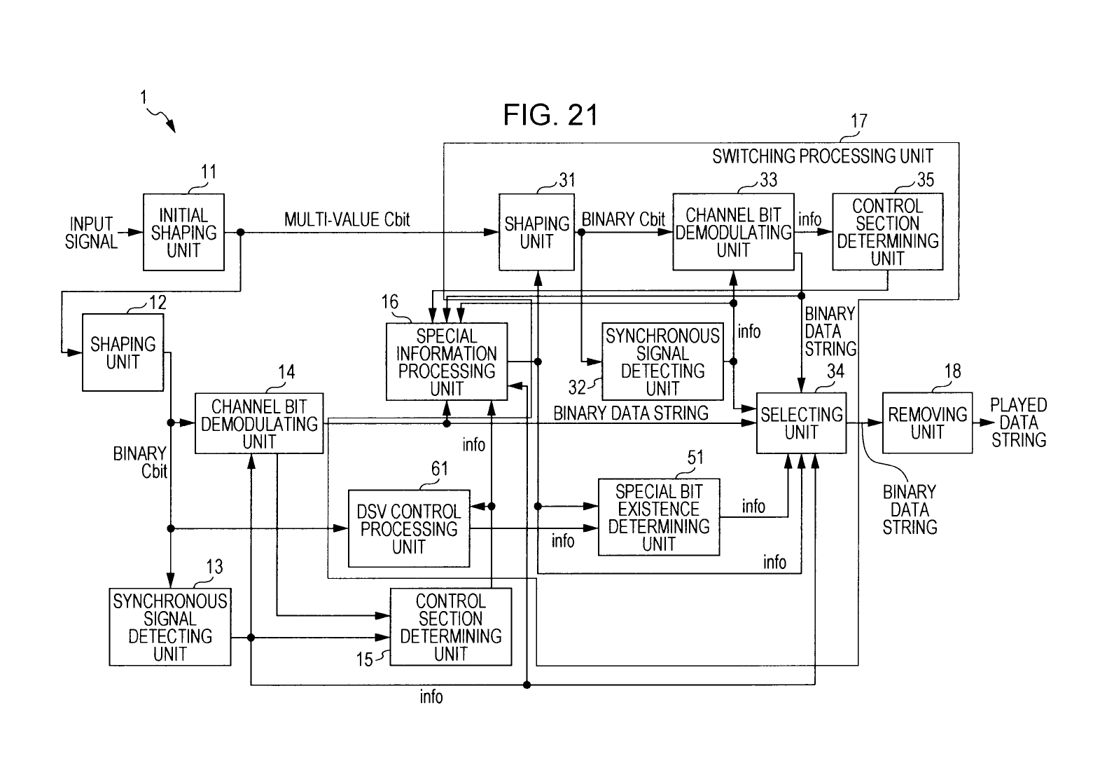

FIG. 21 is a diagram illustrating a modification of the configuration of the data demodulating device 1 in FIG. 20. The configuration of the data demodulating device 1 illustrated in FIG. 21 differs from the configuration in FIG. 20 in that a control section determining unit 35 is additionally provided to the switching processing unit 17. With the data demodulating device 1 in FIG. 21 as well, as described with reference to FIG. 15, determination is made whether or not there is a special bit, based on the signal subjected to the second shaping processing as appropriate.

### Operation of Data Demodulating Device

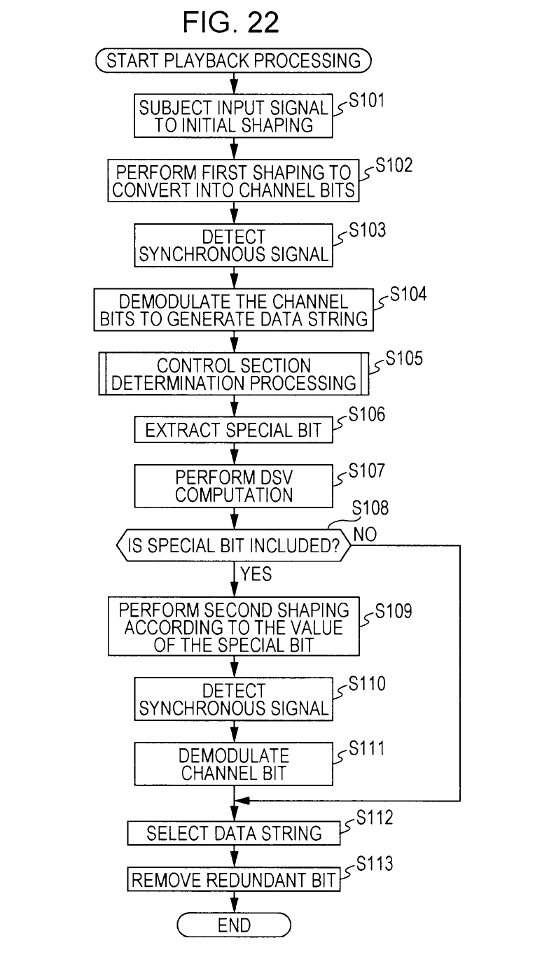

The playback processing of the data demodulating device 1 in FIG. 20 will be described with reference to the flowchart in FIG. 22.

In step S101, the initial shaping unit 11 performs initial shaping of an input signal.

In step S102, the shaping unit 12 performs the first shaping processing as to the input signal subjected to the initial shaping, and further performs binary conversion, thereby generating a channel bit string.

In step S103, the synchronous signal detecting unit 13 detects a synchronous signal from the channel bit string generated by the shaping unit 12. As described above, the synchronous signal detecting unit 13 in FIG. 20 does not have a function for detecting identification information included in a synchronous signal, and accordingly, detection of identification information is not performed here.

In step S104, the channel bit demodulating unit 14 demodulates the channel bit string generated by the shaping unit 12 to output a binary data string.

In step S105, the control section determining unit 15 executes control section determination processing. According to the control section determination processing, a DSV control section serving as a DSV computation object, and a special computation section are determined. The control section determination processing performed here is the same processing as the processing described with reference to the flowchart in FIG. 6.

In step S106, the special information processing unit 16 extracts an information bit from the data string supplied from the channel bit demodulating unit 14. The information bit extracted by the special information processing unit 16 may be a special bit or DSV bit.

In step S107, the DSV control processing unit 61 computes a DSV for each DSV control section of the channel bit string supplied from the shaping unit 12, and performs DSV computation that is processing for computing the accumulated value of a DSV. The DSV control sections are specified by the control section determining unit 15.

In step S108, the special bit existence determining unit 51 determines whether or not a special bit is included in the data string, for example, by comparing a DSV obtained by the DSV control processing unit 61 with a reference value.

In the event that determination is made in step S108 that a special bit is included in the data string, in step S109 the shaping unit 31 performs second shaping processing according to the value of the special bit as to the channel bit string supplied from the initial shaping unit 11. Also, the shaping unit 31 converts the multi-value channel bit string subject to the second shaping processing into a binary channel bit string.

In step S110, the synchronous signal detecting unit 32 detects a synchronous signal inserted into the channel bit string generated by the shaping unit 31.

In step S111, the channel bit demodulating unit 33 demodulates the channel bit string generated by the shaping unit 31 to output a binary data string.

In the event that determination is made in step S108 that no special bit is included in the data string, the processing in steps S109 through S111 is skipped.

In step S112, the selecting unit 34 selects a data string. Specifically, in the event that a special bit is included in the data string, the selecting unit 34 selects the data string supplied from the channel bit demodulating unit 33, and in the event that no special bit is included in the data string, selects the data string supplied from the channel bit demodulating unit 14.

In step S113, the removing unit 18 removes redundant bits from the data string selected by the switching processing unit 17, and outputs the data string from which the redundant bits are removed, as a playback data string. Thereafter, the processing is ended.

According to such processing, with the data demodulating device 1 having no function for detecting identification information included a synchronous signal as well, determination is made whether or not there is a special bit, and in the event that a special bit is included, processing can be performed according to the value of the special bit.

### Modifications

With the above embodiments, an arrangement has been made wherein identification information representing whether or not there is a special bit is principally added as additional information include in a synchronous signal block, but various types of information may be added.

For example, a particular pattern regarding a control delimiter technique may be described as additional information included in a synchronous signal block. This description may be a case where, the position of an information bit inserted into data is taken as a reference, and a control delimiter B is set in a position immediately after a bit prior to the information bit with a certain number of bits being sandwiched therebetween. In this case, information based on the channel bits after a fixed delimiter may be taken as additional information. Thus, recoding/playback processing can be performed in a surer manner.

Also, with the above embodiments, an example using one special bit has been described, but a case where the content of signal processing for a special computation section object is specified by multiple special bits can be realized in the same way. For example, in the event that the content of signal processing is specified using two special bits, four types of processing can be specified by a combination of the two special bits.

At this time, predetermined positions are set as the positions of the two bits, and for example, when the two bits are made up of the first special bit from SYNC, and the next emerging special bit thereof, the demodulating device according to an embodiment of the present disclosure can also be configured in the same way by detecting these bits.

With regard to the configuration at this time, in the event that four kinds of switching are employed using two bits, for example, the number of the switching processing units 17 in FIG. 3 is increased from one in FIG. 3 to three. In FIG. 14, the numbers of the shaping units 31, synchronous signal detecting units 32, and channel bit demodulating units 33 are increased from one to three respectively, and also, results thereof are collected at the selecting unit 34 to perform selection. In FIG. 17, the numbers of the shaping units 31, synchronous signal detecting units 32, channel bit demodulating units 33, and special bit existence determining units 51 are increased from one to three respectively, and also, results thereof are collected at the selecting unit 34 to perform selection.

Further, with the above embodiments, an arrangement has been made wherein one special bit is inserted into each of the special computation sections, but an arrangement may be made wherein a special bit that takes the entire FS section as an object is inserted. Also, an arrangement may be made wherein a special bit that takes the entire data in increments of blocks described with reference to FIG. 4 as an object is inserted.

An embodiment of the present disclosure may be applied to a Blu-ray disc recorder, in addition thereto, a device for playing data recorded in a recording medium.

### Configuration of Computer

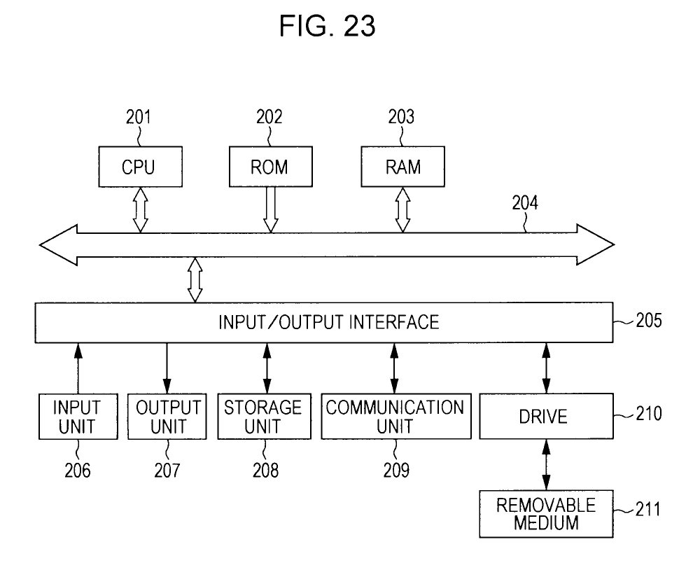

FIG. 23 is a block diagram illustrating a configuration example of the hardware of a computer which executes the above series of processing by a program. A CPU (Central Processing Unit) 201, ROM (Read Only Memory) 202, and RAM (Random Access Memory) 203 are mutually connected by a bus 204. Further, an input/output interface 205 is connected to the bus 204. An input unit 206, an output unit 207, a storage unit 208, a communication unit 209, and a drive 210 are connected to the input/output interface 205.

The input unit 206 is made up of a keyboard, a mouse, a microphone, and so forth. The output unit 207 is made up of a display, speakers, and so forth. The storage unit 208 is made up of a hard disk, nonvolatile memory, and so forth. The communication unit 209 is made up of a network interface and so forth. The drive 210 drives a removable medium 211 such as a magnetic disk, an optical disc, a magneto-optical disk, or semiconductor memory.

With the computer thus configured, for example, the CPU 201 loads a program stored in the storage unit 208 into the RAM 203 via the input/output interface 205 and bus 204 to execute the program, whereby the above series of processing is performed.

The program that the computer (CPU 201) executes may be provided by being recorded in the removable medium 211 serving as a package medium or the like, for example. Also, the program may be provided via a cable or wireless transmission medium such as a local area network, the Internet, a digital satellite broadcast.

With the computer, the program may be installed into the storage unit 208 via the input/output interface 205 by mounting the removable medium 211 on the drive 210. Also, an arrangement may be made wherein the program is received at the communication unit 209 via a cable or wireless transmission medium, and is installed into the storage unit 208. In addition, the program may be installed into the ROM 202 or storage unit 208 beforehand.

Note that the program that the computer executes may be a program wherein processing is in the time sequence in accordance with the order described in the present Specification, or may be a program wherein processing is performed in parallel or at timing used for performing call-up or the like.

Note that embodiments of the present disclosure are not restricted to the above embodiments, and various modifications may be made without departing from the essence of the present disclosure.

The present disclosure contains subject matter related to that disclosed in Japanese Priority Patent Application JP 2010-134035 filed in the Japan Patent Office on Jun. 11, 2010, and Japanese Priority Patent Application JP 2010-135914 filed in the Japan Patent Office on Jun. 15, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A data demodulating device which converts an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to said modulation table,
said data demodulating device comprising:
a shaping unit configured to subject to two or more signal processes; and
a selecting unit configured to select the content of said signal process by said shaping unit based on said information bits.

2. The data demodulating device according to claim 1, further comprising:
a first conversion unit configured to convert said RLL codes into a first data string in accordance with the demodulation table corresponding to said modulation table;
a setting unit configured to set said first data string to a control section which is an object of said information bits; and
a second conversion unit configured to convert said RLL code string made up of said RLL codes subjected to said signal process by said shaping unit into a second data string in accordance with said demodulation table;
wherein said shaping unit subjects said RLL code of a section corresponding to said control section which is an object of said special bit, of RLL codes included in said RLL code string, to a different signal process according to the value of said special bit;
and wherein said selecting unit outputs said second data string as playback data of said control section which is an object of said special bit, and output said first data string as other playback data of said control section.

3. The data demodulating device according to claim 1, wherein said information bits include
DSV bits used for DSV control of a target section, and
said special bit inserted instead of a part of said DSV bits.

4. The data demodulating device according to claim 1, wherein in the event that said input signal is a signal obtained by playing a recording medium, the value of said special bit differs according to recoded positions in said recording medium of said RLL codes obtained by modulating data within a target section in accordance with said modulation table.

5. The data demodulating device according to claim 1, wherein the value of said special bit differs according to whether or not the number of times of occurrence of the minimum run that is succession of zeros or succession of ones of said RLL codes obtained by modulating data within a target section in accordance with said modulation table is greater than a threshold.

6. The data demodulating device according to claim 2, further comprising:
a detecting unit configured to detect a synchronous signal including identification information representing whether or not said special bit is inserted into said data string that has been synthesized with said RLL code string;
wherein said selecting unit performs, in the event that said identification information included in said synchronous signal represents that said special bit is inserted into said data string, output of said second data string.

7. The data demodulating device according to claim 2, further comprising:
a determining unit configured to determine whether or not said special bit is inserted into said data string, based on change of the values of said information bits;
wherein said selecting unit performs, in the event that determination is made that said special bit is inserted into said data string so that the values of said information bits have not been changed for a certain period or more, output of said second data string.

8. The data demodulating device according to claim 2, further comprising:
a computing unit configured to perform a DSV computation of said control section set by said setting unit which is an object of said DSV bits, based on DSV bits used for DSV control of a target section included in said information bits, and said DSV bits of said special bits inserted instead of a part of said DSV bits; and
a determining unit configured to determine whether or not said special bit is inserted into said data string by comparing the results of said DSV computation and a threshold;
wherein said selecting unit performs, in the event that determination is made that said special bit is inserted into said data string since the results of said DSV computation is greater than the threshold, output of said second data string.

9. A data demodulating method of a data demodulating device including a shaping unit which subjects to two or more signal processes which convert an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to said modulation table,
said method comprising:
selecting the content of said signal process by said shaping unit based on said information bits.

10. A program causing a computer to execute processing of a data demodulating device including a shaping unit which subjects to two or more signal processes which convert an RLL code string obtained by converting a data string in which information bits including a special bit having a value representing the content of a signal process at the time of demodulating data within a target section included in an input signal are inserted with a constant interval in accordance with a modulation table having a variable length conversion rule, in accordance with a demodulation table corresponding to said modulation table,
said processing comprising:
selecting the content of said signal process by said shaping unit based on said information bits.
